(19) United States
(12) Patent Application Publication
(10) Pub. No.: US 2026/0181549 A1
(43) Pub. Date: Jun. 25, 2026

(54) METHODS AND APPARATUS FOR EXTENDING COVERAGE FOR LOW POWER WAKE-UP SIGNALS

(71) Applicant: InterDigital Patent Holdings, Inc., Wilmington, DE (US)

(72) Inventors: Jongwoo HONG, New York, NY (US); Young Woo KWAK, Woodbury, NY (US); Moon IL LEE, Melville, NY (US); Prasanna HERATH, Laval (CA); Nazli KHAN BEIGI, Longueuil (CA); Brian MARTIN, Farnham (GB); Virgile GARCIA, Antibes (FR)

(73) Assignee: InterDigital Patent Holdings, Inc., Wilmington, DE (US)

(21) Appl. No.: 18/990,871

(22) Filed: Dec. 20, 2024

(51) Int. Cl. H04W 52/02; H04W 24/10; H04W 68/02

(52) U.S. Cl. CPC H04W 52/0229; H04W 24/10; H04W 68/02

(57) ABSTRACT

A first wireless transmit/receive unit (WTRU) is disclosed. The WTRU may comprise a first radio, a second radio, and a processor. The processor may be configured to receive first configuration information for monitoring for at least one low power wake-up signal (LP-WUS) transmitted by a network. The processor may also be configured to receive second configuration information for monitoring for at least one LP-WUS transmitted by a second WTRU. Further, the processor may be configured to activate the second radio to monitor for a LP-WUS transmitted by the network based on the first configuration information and to monitor for a LP-WUS transmitted by the second WTRU based on the second configuration information.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth-generation (4G) long-term evolution (LTE). Wireless communication devices may establish communications with other devices and data networks, e.g., via an access network, such as a radio access network (RAN).

### SUMMARY

Methods and apparatus for extending coverage of low power signals, such as low-power wake-up signals, are disclosed. The methods and apparatus may enable monitoring for low power wake-up signals (LP-WUSs) transmitted by a network and/or LP-WUSs transmitted by another WTRU, such as a relay WTRU. In one aspect, a first wireless transmit/receive unit (WTRU) is disclosed. The WTRU may comprise a first radio, a second radio, and a processor. The processor may be configured to receive first configuration information for monitoring for at least one low power wake-up signal (LP-WUS) transmitted by a network. The processor may also be configured to receive second configuration information for monitoring for at least one LP-WUS transmitted by a second WTRU. Further, the processor may be configured to activate the second radio to monitor for a LP-WUS transmitted by the network based on the first configuration information and to monitor for a LP-WUS transmitted by the second WTRU based on the second configuration information.

In another aspect, a method implemented by a first wireless transmit/receive unit (WTRU) having a first and second radio is disclosed. The method may include receiving first configuration information for monitoring for at least one low-power wake-up signal (LP-WUS) transmitted by a network. The method may also include receiving second configuration information for monitoring for at least one LP-WUS transmitted by a second WTRU. The method may also include activating the second radio to monitor for a LP-WUS transmitted by the network based on the first configuration information and to monitor for a LP-WUS transmitted by the second WTRU based on the second configuration information.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates a wireless transmit/receive unit (WTRU), according to an exemplary embodiment;

FIG. 3 illustrates an example of extending low power coverage using a relay WTRU.

FIG. 4 illustrates an example of an idle mode wake-up signal in LTE Release 15;

FIG. 4A illustrates an example of the operation of a WTRU for Release16 without PEI and Release 17 with PEI;

FIG. 5 illustrates a flow diagram of a method for extending coverage for low power signals, according to an exemplary embodiment;

FIG. 6 illustrates a flow diagram of a method for extending coverage for low power signals, according to another exemplary embodiment;

FIG. 7 illustrates a flow diagram of a method for extending coverage for low power signals, according to another exemplary embodiment;

FIG. 8 illustrates a flow diagram of a method for performing LS-WUS relay discovering, according to an exemplary embodiment; and

FIG. 9 illustrates a flow diagram of a method for LP-WUS relaying and reporting LP-WUS reception, according to an exemplary embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

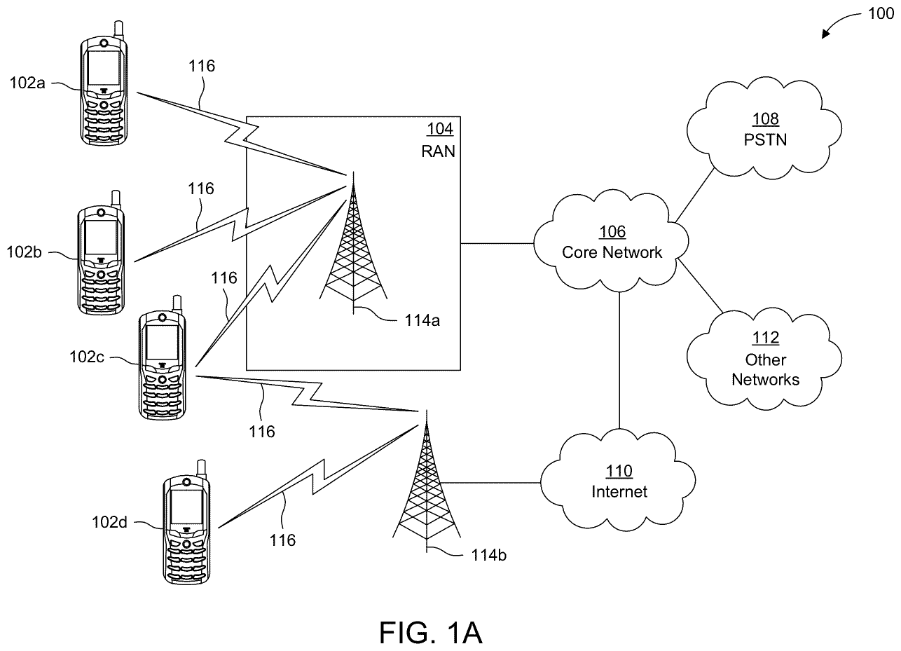

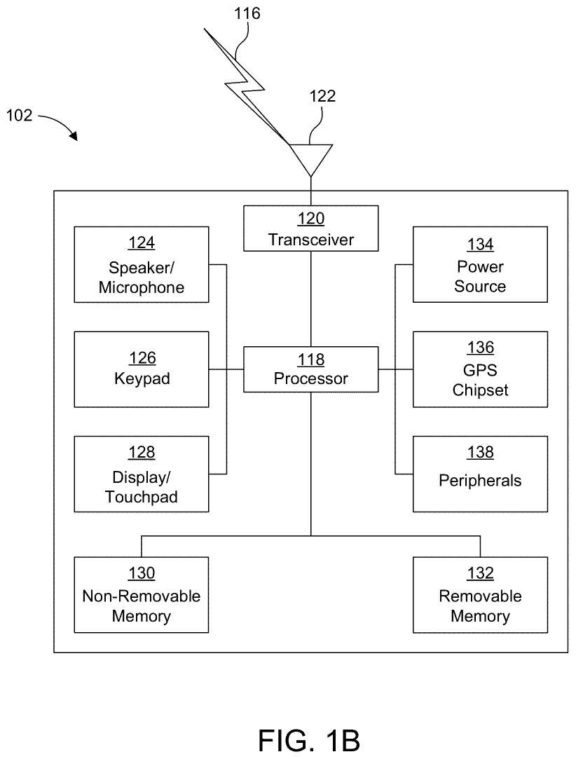

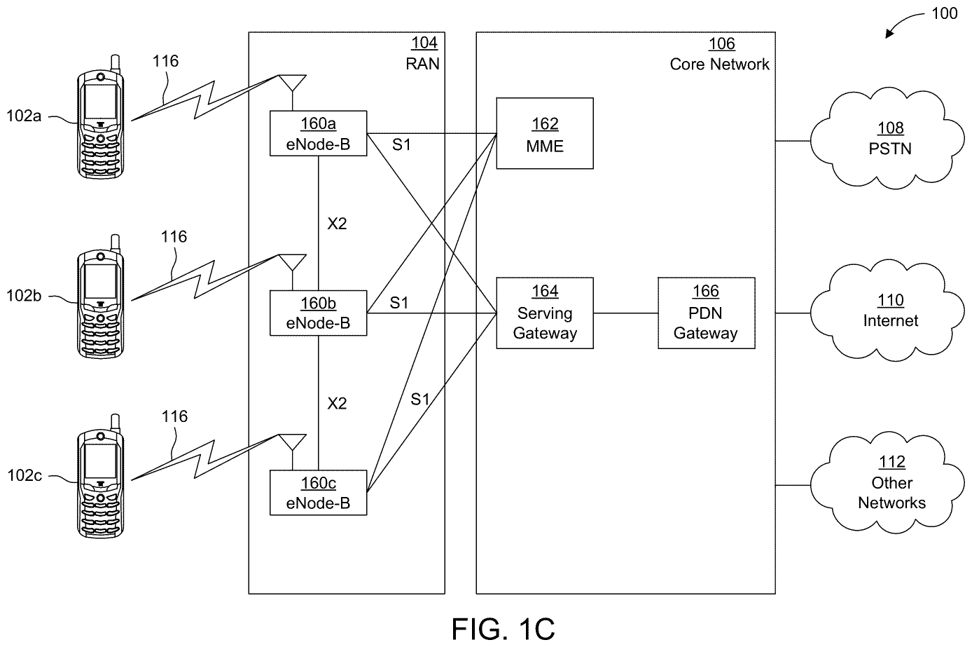

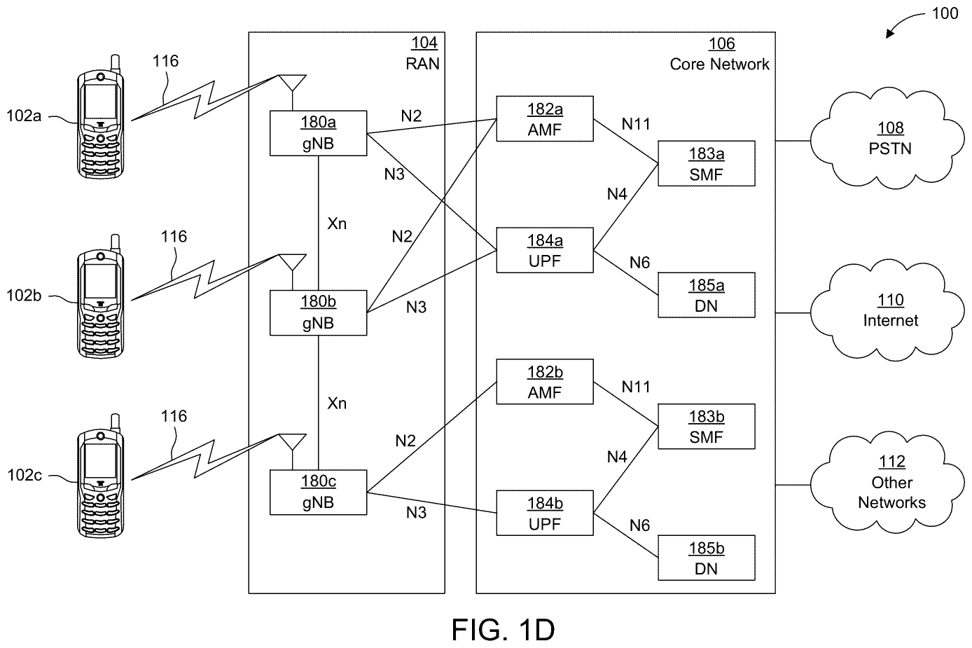

The methods, procedures, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

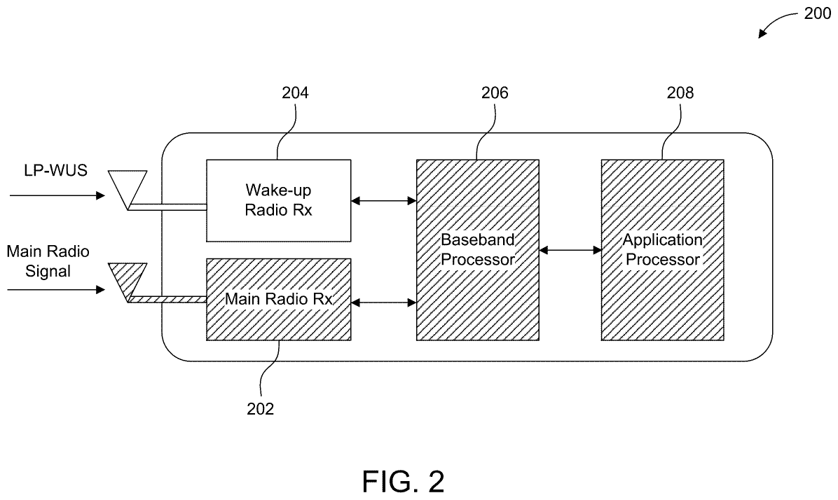

Referring now to FIG. 2, an exemplary WTRU 200 is illustrated. The WTRU 200 may have a first radio and a second radio. The first radio may be a main radio (MR) 202 and the second radio may be a low power radio (LR) 202 (e.g. a low-power or ultra-low wake-up radio (LP-WUR). The type of LR 204 (e.g., the second radio) may be an OOK-based radio or receiver, an OFDM-based radio or receiver, or any other suitable receiver. The WTRU 200 may monitor and receive a low power wake-up signal (LP-WUS) via the LR 204. The LR 204 can reduce power consumption of the WTRU 200. For example, the LR 204 can monitor wake-up signals (WUSs) and trigger and/or wake-up the MR 202 dedicated for data and control signal transmission and/or reception. The WTRU 200 may also include a baseband processor 206 and an application processor 208.

The WTRU 200 may be configured with entry and/or exit conditions for LP-WUS monitoring in IDLE/INACTIVE mode. The WTRU 200 may be configured to start monitoring for a LP-WUS when a serving cell measurement performed by the MR 202 is above one or more entry thresholds. When the WTRU 200 starts LP-WUS monitoring, it may stop paging occasion (PO) monitoring before the WTRU 200 receives a LP-WUS indicating wake-up. The WTRU 200 monitors the PO (and may monitor paging early indication (PEI)) and may stop LP-WUS monitoring when the serving cell measurement performed by the LR 204 is below one or more exit thresholds.

The LP-WUS monitoring entry/exit conditions at least for IDLE/INACTIVE may be based on MR measurements (and LR measurements) of signals from the network. In some cases, the WTRU 200 may be under MR coverage but may not activate the low-power based monitoring (e.g., due to reaching the exit conditions and switching back to regular monitoring) to avoid coverage issues. As a result, the WTRU 200 may not benefit from the full energy saving particularly at the cell-edges or for higher-frequency cells with reduced coverage. For example, the coverage areas of the MR 202 and the LR 204 may be different (e.g., due to signal design, configuration, propagation, etc.). The exit condition threshold of the LR 204 may also be more conservative than the MR 202 to avoid losing cell coverage while monitoring for LP-WUS, to ensure reliability of the LP-WUS reception, and to avoid any mismatch between LR and MR measurements and coverage.

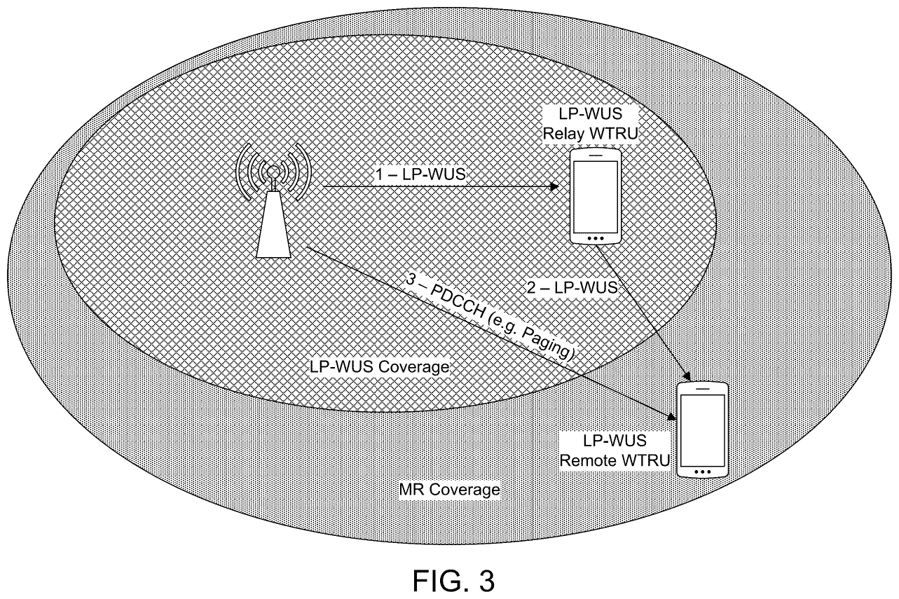

A WTRU (e.g., a relay WTRU) may be capable of relaying a LP-WUS to another WTRU (e.g., a remote WTRU or WTRU 200), when the relay is in coverage and the WTRU 200 may benefit from extended LP-WUS coverage. A WTRU capable of forwarding or relaying the LP-WUS to WTRU 200 may be selected as a relay WTRU. FIG. 3 illustrates an example of extending low power coverage using a relay WTRU. The WTRU 200 may receive a configuration for monitoring the LP-WUS from the network and/or a relay WTRU.

The LR 204 of the WTRU 200 may be configured with monitoring windows to monitor and detect potential LP-WUSs. The LR 204 may be configured with a duty cycle for the monitoring situations, where the duty cycle and the monitoring windows may be selected to match with LP-WUS transmission time from a Network (NW) or base station. The time and frequency synchronization of the WTRU 200 are based on receiving Synchronization Signal Blocks (SSB) and using Primary Synchronization Signals (PSS) and/or Secondary Synchronization Signals (SSS) for synchronization. For example, the WTRU 200 may receive a synchronization signal/physical broadcast channel (SS/PBCH) block. The SS/PBCH block (SSB) may include a primary synchronization signal (PSS), a secondary synchronization signal (SSS), and a physical broadcast channel (PBCH). The WTRU 200 may monitor, receive, or attempt to decode one or more SSBs during initial access, initial synchronization, radio link monitoring (RLM), cell search, cell switching, and so forth.

The WTRU 200 may receive the SSBs during an “ON mode” of the MR 202, where the WTRU 200 may use the received SSB for synchronization. However, in cases where the MR 202 is configured with a long “OFF mode” or sleeping periods, the clock frequency may drift at the WTRU 200. The clock frequency drift or frequency error may result in inaccuracy of the duty cycle of the LR 204. The difference in the clock of the NW and the clock frequency of the LR 204 may result in time mismatch between the LP-WUS transmission time from the NW and a monitoring window of the LR 204. The time mismatch may lead to failed detection of LP-WUS.

To avoid the time mismatch between the LP-WUS transmission time from NW and a monitoring window of the LR 204, the WTRU 200 may be configured to detect and receive periodic Low Power Synchronization Signals (LP-SS) to achieve accurate synchronization at the LR 204. LP-SS may be based on On-Off Keying (OOK) symbols forming binary sequences, where the WTRU 200 with a LP-WUS configuration may use the LR 204 (e.g., based on OOK receivers) to detect and receive the LP-SS. The LP-SS may be used for time and frequency synchronization with the serving cell. Moreover, the WTRU 200 may use the LP-SS for RRM measurements. As such, the NW may configure the LP-SS sequence associated with the serving cell in addition to a number of candidate LP-SS sequences associated with one or more neighbor cells, where the WTRU 200 can measure RRM measurements for the serving cell and configured neighbor cells, respectively.

The WTRU 200 may be configured to use one or more sets of reference signals (RSs) to measure one or more cells. A base station may transmit the RSs and associated DL signals to the WTRU 200 via SIB (e.g., cell-specific) and/or RRC dedicated message (e.g., WTRU-specific). The WTRU 200 may be configured to measure the reference or downlink (DL) signals via the MR 202 (e.g., the first radio) and/or the LR 204 (e.g., a LP-WUR or the second radio). In one example, the WTRU 200 may measure a first set of the RSs received by the MR 202. The first set of the RSs may include at least one DL signal (e.g., SS/PBCH/SSB/SSS). Each set of the RSs may be associated with at least one cell (e.g., serving cell and/or neighboring cell). The measurement value of the DL signal received by the MR 202 (e.g., the first radio) may include one or more measurement values (e.g., SS-RSRP and/or SS-RSRQ and/or SS-SINR). Further, the WTRU 200 may measure a second set of the RSs received by the LR 204 or second radio. The second set of the RSs may include at least one DL signal. For example, the DL signal received by the LR 204 may include one or more measurement values (e.g., LP-RSSI and/or LP-RSRP and/or LP-RSRQ and/or LP-SINR).

The WTRU 200 may be configured with one or more thresholds (e.g., for the MR 202 and/or the LR 204)) for the entry and/or exit conditions for LP-WUS monitoring and/or RRM relaxation for serving/neighboring cell measurements. For example, the WTRU 200 may be configured with a threshold for the MR 202 (e.g., the first radio) and the LR 204 (e.g., the second radio) with (pre-)configured offset/compensate value(s). The measurement results of the LR 204 may be applied with the (pre-)configured offset/compensate value(s). The (pre-)configured offset value (e.g., dBm and/or dB) of RSRP/RSRQ/SINR may be applied to the measurement results with the LR 204 (e.g., the second radio).

The base station or network (NW) may transmit configuration information (e.g., thresholds) including conditions to the WTRU 200 via SIB (e.g., cell-specific) and/or RRC dedicated message (e.g., WTRU-specific). The WTRU 200 may also be pre-configured with one or more thresholds and/or conditions. If the network or base station does not provide the threshold for the LR 204 (e.g., the second radio), the WTRU 200 may configure a threshold for the MR 202 (e.g., the first radio) and applied the (pre-)configured offset value to the received threshold for the MR 202. In some examples, the thresholds may be associated with the MR 202 and/or LR 204. In other examples, the WTRU 200 may be configured with one or more thresholds (e.g., bandwidths). In one example, the WTRU 200 may be configured with a bandwidth threshold for triggering measurements by the MR 202. The bandwidth threshold may comprise the size of bandwidth (e.g., number of PRBs, 5 MHz, 10 MHz, etc). In other examples, the WTRU 200 may be configured with a quality threshold associated measured value (e.g., RSSI/RSRP/RSRQ/SINR and LP-RSSI/LP-RSRP/LP-RSRQ/LP-SINR). The thresholds may also be associated with a first DL signal and/or a second DL signal. The WTRU 200 may measure the first DL signal via the MR and/or the LR 204 and the WTRU 200 may measure the second DL signal via the LR 204.

The WTRU 200 may determine measurements of intra-frequency cells, NR inter-frequency cells, and/or inter-RAT frequency cells according to measurement rules or procedures based on a current Srxlev value (e.g., cell selection RX level value) of the serving cell and/or a current Squal value (e.g., cell selection quality value) of the serving cell. The Srxlev value may indicate a RSRP value (e.g., SS-RSRP/LP-RSRP) and the Squal value may indicate RSRQ value (e.g., SS-RSRQ/LP-RSRQ). The WTRU 200 may determine the intra-frequency measurements based on the measurement results. The WTRU 200 may perform measurements of NR inter-frequency cells of equal or lower priority or inter-RAT frequency cells of lower priority based on the measurement results.

The WTRU 200 may be configured for relaxed RRM measurement when a condition (e.g., cell re-selection procedure and relaxation threshold) is satisfied to the quality of the serving cell measurement with MR 202 or the LR 204. The quality for each of the relaxation thresholds may be associated with measurement results of the MR 202 or the LR 204. For example, the WTRU 200 may perform a relaxed RRM measurement for intra frequency/inter-frequency, if the serving cell measurements via MR 202 is above the quality for relaxation threshold of the MR. For example, the WTRU 200 may perform relaxed RRM measurement for intra frequency/inter-frequency if the serving cell measurements via the LR 204 is above the quality for relaxation threshold.

The WTRU 200 may be configured with one or more measurement configurations including periodicities (e.g., msec) associated with the serving cell measurement results. Each of the configurations may be associated with a periodicity of relaxed measurement (e.g., msec). Each of the relaxed configurations may be applied if the threshold (e.g., relaxation threshold) is satisfied. In one example, the high quality of the serving cell measurement (e.g., high measurement value of RSSI/RSRP/RSRQ/SINR) may be associated with a relaxed measurement (e.g., relaxed/longer measurement cycle). The low quality of the serving cell measurement (e.g., low measurement value of RSSI/RSRP/RSRQ/SINR) may be associated with a less relaxed measurement (e.g., less relaxed/short measurement cycle).

The WTRU 200 may determine a mode of measurement (e.g., whether to use MR or not) based on the band difference between the band of the MR 202 and the band of the LR 204 (e.g., NR frequency band), In one example, if the band difference/gap (e.g., between the MR and the LR 204) is smaller than the configured bandwidth threshold, the WTRU 200 may perform measurements only with the LR 204 for determination of measurement relaxation. For example, the WTRU 200 may perform relaxed RRM measurement for intra frequency/inter-frequency if the serving cell measurements via LR 204 is above the quality for relaxation threshold of the LR 204. If the band difference (e.g., between MR 202 and the LR 204 is larger than the configured bandwidth threshold, the WTRU 200 may also perform measurements with the MR 202 during activation of the LR 204 (e.g., measurement MR and LR).

The WTRU 200 may perform measurements for a serving cell and neighboring cells based on first sets of the reference signals (RSs) for the MR 202 and second sets of RSs for the LR 204. For example, the WTRU 200 may determine a set of monitoring configurations based on the measured qualities. If the gap of measured quality in the LR 204 and the measured quality in the MR 202 is smaller than a first threshold (e.g., low difference), the WTRU 200 may determine a first set of monitoring configurations (e.g., longer periodicity) among the configured list of configurations. If the gap of measured quality in the LR 204 and the measured quality in MR 202 is smaller than a second threshold and larger than the first threshold (e.g., high difference), the WTRU 200 may determine a second set of monitoring configurations (e.g., shorter periodicity) among the configured list of configurations.

The WTRU 200 may determine the sets of the RSs (e.g., a first set or second set) for measurements based on the determined monitoring configurations. For example, if the measuring instance is one of a monitoring occasion according to the determined monitoring configuration, the WTRU 200 may measure the first sets of RSs. When a set of monitoring configurations is applied, the WTRU 200 may determine a combined quality of measurements based on the first sets of the RSs and the second sets of the RSs. If the measuring instance is not one of a monitoring occasion according to the determined monitoring configuration, the WTRU 200 may measure the second sets of the RSs.

The WTRU 200 may transmit or receive a physical channel or reference signal according to at least one spatial domain filter. The term “beam” may be used to refer to a spatial domain filter. The WTRU 200 may transmit a physical channel or signal using the same spatial domain filter as the spatial domain filter used for receiving an RS (such as CSI-RS) or a SS block. The transmission by the WTRU 200 may be referred to as “target”, and the received RS or SS block may be referred to as “reference” or “source”. In such case, the WTRU 200 may be said to transmit the target physical channel or signal according to a spatial relation with a reference to the second (reference) physical channel or signal, such RS or SS block.

A spatial relation may be implicit, configured by RRC or signaled by MAC CE or DCI. For example, the WTRU 200 may implicitly transmit PUSCH and DM-RS of PUSCH according to the same spatial domain filter as an SRS indicated by an SRI indicated in DCI or configured by RRC. In another example, a spatial relation may be configured by RRC for an SRS resource indicator (SRI) or signaled by MAC CE for a PUCCH. Such spatial relation may also be referred to as a “beam indication”.

The WTRU 200 may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the WTRU 200 is configured with a quasi-colocation (QCL) assumption type D between corresponding antenna ports. Such association may be configured as a TCI (transmission configuration indicator) state. The WTRU 200 may indicate an association between a CSI-RS or SS block and a DM-RS by an index to a set of TCI states configured by RRC and/or signaled by MAC CE. Such indication may also be referred to as a “beam indication”.

The WTRU 200 may use Discontinuous Reception (DRX) in RRC_IDLE and RRC_INACTIVE state in order to reduce power consumption. The WTRU 200 may monitor one paging occasion (PO) per DRX cycle. A PO is a set of PDCCH monitoring occasions and can consist of multiple time slots (e.g. subframe or OFDM symbol) where paging DCI can be sent. One Paging Frame (PF) is one Radio Frame and may contain one or multiple PO(s) or starting point of a PO. In multi-beam operations, the WTRU 200 may assume that the same paging message and the same Short Message are repeated in all transmitted beams and thus the selection of the beam(s) for the reception of the paging message and Short Message is up to WTRU implementation. The paging message is same for both RAN initiated paging and CN initiated paging. The WTRU 200 may initiate a RRC Connection Resume procedure upon receiving RAN initiated paging. If the WTRU 200 receives a CN initiated paging in RRC_INACTIVE state, the UE moves to RRC_IDLE and informs NAS.

When SearchSpaceId other than 0 is configured for pagingSearchSpace, the WTRU 200 may monitor the (i_s+1)th PO. A PO is a set of ‘S*X ’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]th PDCCH monitoring occasion for paging in the PO corresponds to the Kth transmitted SSB, where x=0,1, . . . , X−1, K=1,2, . . . , S. The PDCCH monitoring occasions for paging which do not overlap with WTRU symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)th PO is the (i_s+1)th value of the firstPDCCH-MonitoringOccasionOfPO parameter; otherwise, it is equal to i_s*S*X. If X>1. When the WTRU 200 detects a PDCCH transmission addressed to P-RNTI within its PO, the WTRU 200 is not required to monitor the subsequent PDCCH monitoring occasions for this PO.

The following parameters may be used for the calculation of PF:
T: DRX cycle of the WTRU (T is determined by the shortest of the WTRU specific DRX value(s), if configured by RRC and/or upper layers and a default DRX value broadcast in system information. In RRC_IDLE state, if WTRU specific DRX is not configured by upper layers, the default value is applied);
N: number of total paging frames in T;
Ns: number of paging occasions for a PF;
PF_offset: offset used for PF determination; and
UE_ID: 5G-S-TMSI mod 1024.
   where parameters Ns, nAndPagingFrameOffset, nrofPDCCH-MonitoringOccasionPerSSB-InPO, and the length of default DRX Cycle are signaled in SIB1. The values of N and PF_offset are derived from the parameter nAndPagingFrameOffset. The parameter first-PDCCH-MonitoringOccasionOfPO is signalled in SIB1 for paging in initial DL BWP. For paging in a DL BWP other than the initial DL BWP, the parameter first-PDCCH-MonitoringOccasionOfPO is signaled in the corresponding BWP configuration. If the WTRU 200 has no 5G-S-TMSI, for instance when the WTRU 200 has not yet registered onto the network, the WTRU 200 shall use as default identity UE_ID=0 in the PF and i_s formulas above.

The WTRU 200 may monitor for or listen to the paging message to determine one or more incoming calls, system information change, ETWS (Earthquake and Tsunami Warning Service) notification for ETWS capable WTRUs, CMAS (Commercial Mobile Alert System) notification, and Extended Access Barring parameters modification. In a RRC Idle state, the WTRU 200 may monitor Short Messages transmitted with paging RNTI (P-RNTI) over DCI and monitor a Paging channel for CN paging using 5G-S-TMSI. In a RRC Inactive state, the WTRU 200 may monitor Short Messages transmitted with P-RNTI over DCI and may monitor a Paging channel for CN paging using 5G-S-TMSI and RAN paging using fullI-RNTI. In a RRC Connected state, the WTRU 200 may monitor Short Messages transmitted with P-RNTI over DCI.

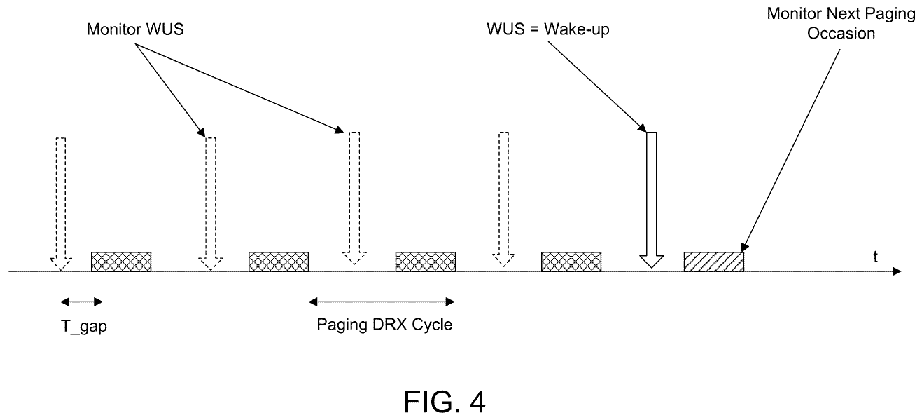

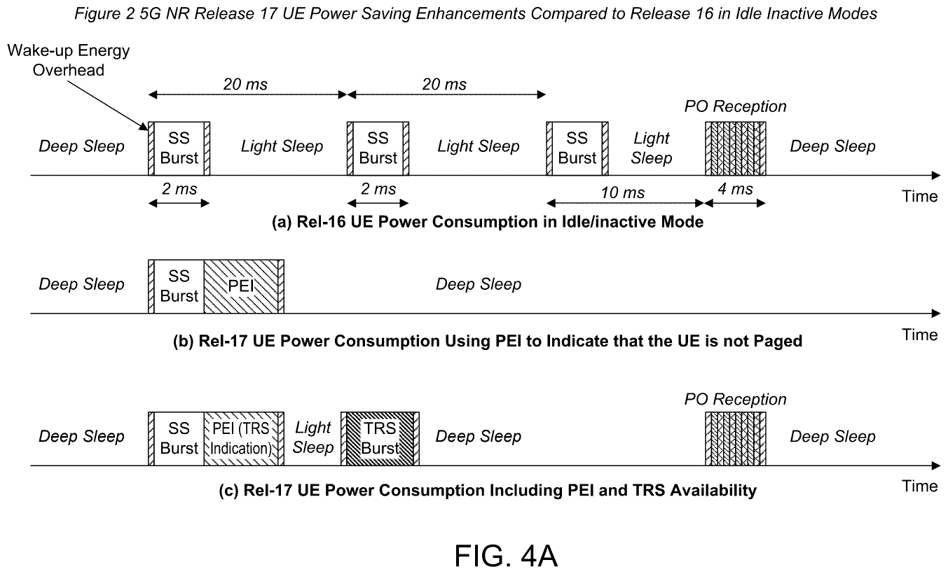

In some communication systems a WTRU wake-up signal for Idle mode paging may be used for WTRUs supporting NB-IoT or eMTC. Similar to the concept described above for connected mode, the WTRU 200 may monitor for a wake-up signal at a time specified by T_gap before the paging occasion as shown in FIG. 4. If the WTRU 200 receives an indication that there may be paging addressed to that WTRU in the next paging time window then the WTRU 200 may monitor PDCCH during each paging occasion of that paging time window. The paging time window may be defined such that WTRUs with a very long DRX in the order of minutes (eDRX) and which may suffer from clock drift compared to the network timing may reliably receive paging.

FIG. 4A illustrates a comparison of power saving enhancements used in idle inactive modes for implementations of communication systems. A wake-up signal for Idle mode paging is shown in FIG. 4A. A paging early indication (PEI) in DCI format 2-7 transmitted prior to the paging occasion will indicate whether the WTRU has to monitor PDCCH and potentially PDSCH to receive a paging message. PEI also includes a paging indication which indicates WTRU subgroups in one or more paging occasions to be used for paging and TRS availability indication for acquiring time/frequency synchronization for paging.

In one implementation shown in FIG. 4A, the WTRU had to wake-up to measure SS burst for time/frequency synchronization and monitor paging occasions (POs); however, in another implementation, the WTRU may maintain deep sleep if the WTRU does not receive PEI. In addition, if the WTRU receives PEI, the WTRU can wake up, measure TRS burst and receive POs. Another benefit of PEI is that the WTRU does not need to periodically wake up to maintain time/frequency synchronization for PO reception as PEI is able to indicate TRS burst for acquiring time/frequency synchronization.

Referring again to FIG. 2, the WTRU 200 may receive configuration information for monitoring LP-WUS, paging, and PEI. The configuration information may be delivered via one or more of SIB (e.g., SIB1), RRC, and MAC CE. The WTRU 200 may receive WTRU ID. For example, 5G-S-TMSI mod 1024 may be used as a WTRU ID. The WTRU 200 may receive information nAndPagingFrameOffset. Based on the received information, the WTRU 200 may determine one or more of the following information. The WTRU 200 may receive/determine the information on number of total paging frames (N) (e.g., via nAndPagingFrameOffset). Candidate values for the number of total paging frames may be different for different serving cell SSB periodicity. The WTRU 200 may receive/determine the information on paging frame offset (e.g., via nAndPagingFrameOffset).

The WTRU 200 may receive information of DRX cycle of the WTRU (T is determined by the shortest of the WTRU specific DRX value(s), if configured by RRC and/or upper layers, and a default DRX value broadcast in system information. The WTRU may use a default value (e.g., In RRC_IDLE state, if WTRU specific DRX is not configured by upper layers, the default value is applied). The WTRU 200 may receive information of number of paging occasions (e.g., per PF) for paging operation. For example, the WTRU may receive one of 1, 2 or 4 paging occasions for paging operation.

The WTRU 200 may receive information of one or more search space sets (e.g., to monitor PDCCH for detection of DCI format 2_7 according to a Type2A-PDCCH CSS set). The WTRU 200 may receive information of number of paging occasions supported by PEI. For example, one of 1, 2, 4 or 8 may be indicated. The WTRU 200 may receive information of PEI payload size. For example, up to 41 bits and 43 bits for licensed and unlicensed spectrums, respectively, may be indicated. The WTRU 200 may receive frame offset for PEI. For example, the WTRU 200 may receive offset from the start of a reference frame for PEI-O (e.g., the start of a frame) to the start of a first paging frame of the paging frames associated with a number of PDCCH monitoring occasions for DCI format 2_7. The WTRU 200 may receive symbol offset for PEI. For example, the WTRU 200 may receive offset (e.g., in number of symbols) from the start of the frame to the start of the first PDCCH monitoring occasion for DCI format 2_7.

The WTRU 200 may receive information of total number of subgroups (e.g., for PEI). For example, the WTRU 200 may receive one or both of subgroupsNumPerPO and subgroupsNumForUEID. Based on the received information, the WTRU 200 may determine whether to use WTRU ID based subgrouping or CN based subgrouping. If subgroupsNumForUEID is absent in subgroupConfig, the subgroup ID based on CN assigned subgrouping, if available for the WTRU, may be used. If both subgroupsNumPerPO and subgroupsNumForUEID are configured, and subgroupsNumForUEID has the same value as subgroupsNumPerPO, the subgroup ID based on UE_ID based subgroupingmay be used in the cell. If both subgroupsNumPerPO and subgroupsNumForUEID are configured, and subgroupsNumForUEID<subgroupsNumPerPO, The subgroup ID based on CN assigned subgrouping, if available for the WTRU, may be used in the cell. Otherwise, the subgroup ID based on UE_ID based subgrouping may be used in the cell. If the WTRU 200 has no CN assigned subgroup ID or does not support CN assigned subgrouping, and there is no configuration for subgroupsNumForUEID, the WTRU 200 may monitors the associated PO.

The WTRU 200 may receive configurations of LOs. For example, based on the configurations of LOs, the WTRU 200 may receive configurations of N*K MOs (e.g., by receiving N*K sets of resources) for each LO where N may be a number of beams corresponding to LP-WUS and K may be a number of LP-WUS MOs for each beam. The WTRU 200 may receive a configuration of one or more of sequence ID, a scrambling ID and cell ID. For example, the WTRU 200 may receive a LP-WUS in the LP-WUS resource by using a sequence which is generated by using the ID and/or data which is scrambled by using the ID (e.g., in time and/or frequency domain).

The WTRU 200 may receive a configuration of signal structure. For example, the WTRU 200 may receive one of support of preamble, preamble length (if configured), message type (e.g., sequence and/or encoded data), number of repetition and etc.. The WTRU 200 may receive a configuration of waveform. For example, the WTRU 200 may receive one of OOK-1, OOK-4, OFDMA or etc. as a waveform of LP-WUS. For OOK-4, M can be additionally configured. The WTRU 200 may receive a configuration of monitoring type. For example, the WTRU 200 may receive one of continuous monitoring and duty-cycled monitoring. The WTRU 200 may receive a configuration of absolute frequency resources. For example, the WTRU 200 may receive a configuration based on one or more of RBs, subbands, BWPs and etc. to indicate frequency resources for receiving LP-WUS. The WTRU 200 may receive a configuration of relative time resources. For example, the WTRU 200 may receive frequency offset (e.g., in RBs/subbands/RBGs) from one or more reference resources. The WTRU 200 may receive a configuration of absolute time resources. For example, the WTRU 200 may receive a configuration based on one or more of periodicity, offsets and etc. The indication of configuration may be based on OFDM symbols, us, slots and etc. The WTRU 200 may receive an implicit configuration of time resources. For example, the WTRU 200 may receive time offset (e.g., in symbols/subframes/frames) from one or more reference resources. The one or more reference resources may be one or more of the start of the frame, an associated paging frame, an associated paging occasion, one or more associated LOs (e.g., for MOs), an associated PEI search space, SSB (PSS or SSS in NR-SS), LP-SS and etc.

The WTRU 200 may receive information of number of subgroups for LP-WUS. The number of subgroups may be total number of subgroups for LP-WUS operation. In some examples, the number of subgruops may be a number of subgroups supported by each LO or MO. The WTRU 200 may determine number of subgroups based on the received information. For example, the WTRU 200 may use the number of subgroups for PEI as the number of subgroups for LP-WUS. In another example, the WTRU may determine the number of subgroups for LP-WUS as a scaling factor*the number of subgroups for PEI. The scaling factor may be indicated via one or more of SIB, RRC and MAC CE.

The WTRU 200 may receive information of LP-WUS payload size. For example, up to 8, 16 or 24 bits may be indicated. The WTRU 200 may receive size of LP-WUS information for each information type. For example, the WTRU 200 may receive a first size of LP-WUS information for a first information type (e.g., for one or more of TRS availability indication, SI change, ETWS/CMAS information and etc.). The WTRU may receive a second size of LP-WUS information for a second information type (e.g., subgroup indication).

The WTRU 200 may receive frame offset for LP-WUS. For example, the WTRU 200 may receive offset from the start of a reference frame for LP-WUS (e.g., the start of a frame) to the start of a first paging frame of the paging frames associated with LP-WUS monitoring. The WTRU may receive symbol offset for LP-WUS. For example, the WTRU 200 may receive offset (e.g., in number of symbols) from the start of the frame to the start of the first LP-WUS monitoring occasion (e.g., for monitoring LP-WUS).

The WTRU 200 may receive subgroup ID(s) from AMF via NAS signaling (e.g., in CN based subgrouping). In some examples, the WTRU 200 may determine the subgroup ID based on the WTRU ID and the total number of subgroups for WTRU ID based subgrouping. The WTRU 200 may receive a subgroup ID for both PEI and LP-WUS). For example, the WTRU 200 may receive a first subgroup ID for PEI and a second subgroup ID for LP-WUS. In some examples, the WTRU 200 may receive a subgroup ID for PEI and may determine a subgroup ID for LP-WUS based on the received information. In another example, the WTRU may determine subgroup IDs for PEI and LP-WUS, respectively, based on the received information (e.g., WTRU ID).

Referring again to FIG. 2, the WTRU 200 may determine one or more associated POs with the WTRU 200. For example, the WTRU 200 may determine one or more associated POs based on the WTRU ID. In an example, the WTRU 200 may determine PO ID based on i_s: floor (UE_ID/N) mod Ns. In some examples, i_PO=((UE_IDmodN)·N_S+i_s ) mod N_PO\hat{ }PEI may be used.

The WTRU 200 may determine one or more LOs associated with the WTRU 200. The WTRU 200 may determine the one or more LOs based on the WTRU ID. For example, an associated LO ID may be floor (UE_ID/N) mod N_LO wherein N_LO may be total number of LOs (e.g., for a PF). Based on the determined POs, the WTRU 200 may determine one or more LOs. For example, a LO may be associated with each PO (e.g., based on time and/or frequency offset). The WTRU 200 may determine a LO which is associated with the determined PO (e.g., based on the WTRU ID). The WTRU 200 may determine one or more associated PFs based on the WTRU ID. Based on the determined PFs, the WTRU 200 may determine one or more LOs. For example, a LO may be associated with each PF (e.g., based on time and/or frequency offset). The WTRU 200 may determine a LO which is associated with the determined PF (e.g., based on the WTRU ID).

The WTRU 200 may determine one or more MOs associated the WTRU 200. The WTRU 200 may determine the one or more LOs based on the WTRU ID. Based on the determined PO, the WTRU 200 may determine one or more MOs. For example, one or more MOs may be associated with each PO (e.g., based on time and/or frequency offset). The WTRU 200 may determine one or more MOs which is associated with the determined PO (e.g., based on the WTRU ID). Based on the determined LO, the WTRU 200 may determine one or more MOs. For example, a LO may be associated with each PO (e.g., based on time and/or frequency offset). The WTRU 200 may determine one or more MOs which is associated with the determined PO (e.g., based on the WTRU ID). The WTRU 200 may determine one or more associated PFs based on the WTRU ID. Based on the determined PFs, the WTRU 200 may determine one or more LOs. For example, a LO may be associated with each PF (e.g., based on time and/or frequency offset). The WTRU 200 may determine a LO which is associated with the determined PF (e.g., based on the WTRU ID).

The WTRU 200 may determine LP-WUS information based on the received information. For example, the WTRU 200 may determine whether to split the subgroup information into two or more LOs and/or MOs. The WTRU 200 may determine whether to split the subgroup information based on the size of LP-WUS information. For example, the WTRU 200 may determine the number of subgroups based on the size of LP-WUS information (e.g., for subgroups) and the number of subgroups for LP-WUS. If the size of LP-WUS information (e.g., for all LP-WUS or all subgroup information)>=required size of information for all subgroups (e.g., the number of all subgroups (e.g., for LP-WUS) if bitmap is used), the WTRU 200 may receive information of all subgroups within one associated LO or MO of the LP-WUS with the WTRU 200. If the size of LP-WUS information (e.g., for all LP-WUS or all subgroup information)<required size of information for all subgroups (e.g., the number of subgroups (e.g., for LP-WUS) if bitmap is used), the WTRU 200 may receive information of all subgroups within two or more associated LOs or MOs.

Based on the determination, the WTRU 200 may split the subgroup information into two or more LOs and/or MOs. The WTRU 200 may receive a number of subgroups for each LO or MO (e.g., via one or more of SIB, RRC and MAC CE). Based on the number of subgroups, the WTRU 200 may determine LOs or MOs indicating a set of subgroups. For example, if 8 subgroup is supported and 4 subgroups for each MO is indicated, then first 4 subgroup information may be indicated in a first MO and second 4 subgroup information may be indicated in a second MO.

The WTRU 200 may determine a number of subgroups for each LO or MO based on the number of associated LOs (e.g., per PO or paging frame e.g., within a same beam) or POs (e.g., per LO, PO or paging frame e.g., within a same beam). The WTRU 200 may receive S subgroups in each MO wherein S may be total number of subgroups/K (number of MOs within a LO with a same beam). The WTRU 200 may receive a total number of subgroups for PEI (e.g., via one or more of SIB, RRC and MAC CE). For example, the WTRU 200 may receive indication of the total number of subgroups for PEI in each LO or MO. For example, if 8 subgroups are configured for PEI and 16 subgroups are configured for LP-WUS, then a first MO may indicate a first 8 subgroup and a second MO may indicate a second 8 subgroup.

The WTRU 200 may determine a subgroup ID of the WTRU for LP-WUS. The WTRU 200 may use a same subgroup ID used for PEI. The same subgroup ID may be used if number of subgroups for LP-WUS is same with number of subgroups for PEI (e.g., if number of subgroup in LP-WUS=number of subgroup in PEI). The WTRU 200 may receive an indication of a subgroup ID for LP-WUS (e.g., via one or more of NAS signaling from AMF, SIB, RRC and MAC CE). The WTRU 200 may determine a subgroup ID for LP-WUS. For example, the WTRU 200 may determine a WTRU subgroup ID for LP-WUS based on the WTRU subgroup ID for PEI. For example, e.g., if number of subgroup in LP-WUS>number of subgroup in PEI, WTRU subgroup ID in LP-WUS may be WTRU subgroup ID in PEI*Number of subgroup in LP-WUS/number of subgroup in PEI (or indicated scaling factor)+mod(UE_ID, Number of subgroup in LP-WUS/number of subgroup in PEI (or indicated scaling factor)). In some examples, e.g., if number of subgroup in LP-WUS<number of subgroup in PEI, WTRU subgroup ID in LP-WUS may be floor (WTRU subgroup ID/Number of subgroup in LP-WUS*number of subgroup in PEI).

The WTRU 200 may determine LOs and MOs to monitor. The WTRU 200 may monitor all LOs/MOs associated with the WTRU 200 (e.g., based on WTRU ID and the associated PO). In some examples, the WTRU 200 may monitor LOs/MOs associated with the WTRU's subgroup ID (e.g., among the LOs/MOs associated with the WTRU ID and the associated PO). In other examples, the WTRU 200 may only monitor LOs/MOs which indicates the determined WTRU's subgroup ID. Further, the WTRU 200 may monitor LOs/MOs delivering common information. For example, the WTRU 200 may monitor LOs/MOs delivering TRS availability information, SI change, ETWS/CMAS information and etc.

The WTRU 200 may be configured with one or more LP-WUS monitoring configurations. For example, a monitoring type (e.g., continuous or duty cycled), a monitoring window (periodicity and/or offset), LP-WUS bandwidth, Low Power Synchronization Signal (LP-SS) configuration, etc. may be configured. If the WTRU 200 receives/detects one or more LP-WUSs, the WTRU 200 may apply one or more of the following procedures after receiving/detecting one or more LP-WUSs. The WTRU 200 may wake up (e.g., activate main radio (MR) and/or deactivate low power wake-up receiver (LP-WUR)) and start monitoring of PDCCH (e.g., for paging).

The WTRU 200 may apply update of SI based on the received LP-WUS. For example, the WTRU 200 may apply one or more indicated sets of SI (e.g., by LP-WUS) after receiving the one or more LP-WUSs. In some examples, the WTRU 200 may receive updated SI (e.g., via LP-WUSs and/or PDSCHs after activating MR). The WTRU 200 may apply updated paging related information based on the received LP-WUS. For example, the WTRU 200 may apply one or more indicated sets of paging related information (e.g., by LP-WUS) after receiving the one or more LP-WUSs. The WTRU 200 may receive additional updated paging related information (e.g., via LP-WUSs and/or PDSCHs after activating MR). If the WTRU 200 does not receive/detect one or more LP-WUSs, the WTRU 200 may continue monitoring for the LP-WUS based on the one or more LP-WUS monitoring configurations.

The WTRU 200 may be configured with one or more modes of operation, for example in systems based on LP-WUS. For example, the WTRU 200 may be configured with MR-ON mode and MR-OFF mode. The WTRU 200 may alternate and/or switch between operating in an MR-ON mode and an MR-OFF mode. The WTRU 200 may save power being in MR-OFF mode, and the WTRU 200 may enter MR-ON mode upon receiving an LP-WUS.

The WTRU 200 may determine to switch from MR-ON to MR-OFF when some conditions (“entry conditions”) are satisfied. For example, the WTRU 200 may receive from the network a configuration (e.g., from SIB or RRC), including the measurement on the MR (e.g., based on SSB or CSI-RS measurements) being above a threshold. The WTRU 200 may also receive from the network a configuration (e.g., from SIB or RRC), including the measurement on the LR 204 (e.g., based on LP-SS or LP-WUS measurements) being above a threshold. The WTRU 200 may be preconfigured with conditions, e.g., based on implementations. When the (pre)configured conditions are satisfied, the WTRU 200 may switch from MR-ON to MR-OFF.

The WTRU 200 may determine to switch from MR-OFF to MR-ON when some conditions (“exit conditions”) are satisfied. For example, the WTRU 200 may receive from the network a configuration (e.g., from SIB or RRC), including the measurement on the LR 204 (e.g., based on LP-SS or LP-WUS measurements) being below a threshold. The WTRU 200 may be preconfigured with conditions, e.g., based on implementations. When the (pre)configured conditions are satisfied, the WTRU 200 may switch from MR-OFF to MR-ON.

The WTRU 200 in MR-ON mode may turn on the MR 202 and use the MR 202 to send and/or receive channels, signals, etc., for example to and/or from a Node-B. The WTRU 200 in MR-ON mode may monitor, detect, receive and/or measure one or more reference signals, for example SSB, CSI-RS, PT-RS, DR-RS, etc.

The WTRU 200 in MR-OFF mode may turn off the MR 202 and may use the LR 204 (e.g., LP-WUR) to receive one or more low-power signals, channels, etc. For example, the WTRU 200 in MR-OFF mode may monitor, detect, receive and/or measure one or more Low-Power Synchronization Signaling (LP-SS) and/or LP-WUS. During MR-OFF mode, the WTRU 200 may monitor to receive and/or detect one or more configured LP-WUS and may wake up MR 202 and switch to MR-ON mode upon reception of at least one LP-WUS.

The WTRU 200 in MR-OFF mode, for example, may use the LR 204 (e.g., LP-WUR) to monitor the LP-SS signal to obtain necessary synchronization. For example, the WTRU 200, in RRC-Idle and/or RRC-Inactive states in MR-OFF mode, may need to switch to MR-ON mode and to wake up MR 202 after receiving and/or detecting LP-WUS. After waking up the MR 202 and switching to MR-ON mode, the WTRU 200 may monitor one or more paging occasions (PO), for example to receive paging messages. After receiving the paging message and based on the received paging message, the WTRU 200 may switch to RRC-Connected state, transmit, and/or receive one or more indicated signals and/or channels, and so forth. After transmitting and/or receiving the indicated signals and/or channels, the WTRU 200 may turn off the MR 202 and switch back to MR-OFF mode. In some examples, the WTRU 200 in RRC-Connected state in MR-OFF mode may need to switch to MR-ON mode and to wake up MR 202 after receiving and/or detecting LP-WUS. After waking up the MR 202 and switching to MR-ON mode, the WTRU 200 may monitor to receive PDCCH in one or more configured CORESETs (control channel resource sets) and/or CSS (common search space). The received PDCCH may include grant indications for one or more UL and/or DL transmissions and/or receptions. In some examples, the WTRU 200 in MR-ON mode may be configured to transmit on or more CSI reports. After transmitting and/or receiving based on the configurations and/or indicated grant indication, the WTRU 200 may turn off the MR 202 and switch back to MR-OFF mode.

The WTRU 200 may report a subset of channel state information (CSI) components, where CSI components may correspond to at least a CSI-RS resource indicator (CRI), a SSB resource indicator (SSBRI), an indication of a panel used for reception at the WTRU 200 (such as a panel identity or group identity), measurements such as L1-RSRP, L1-SINR taken from SSB or CSI-RS (e.g. cri-RSRP, cri-SINR, ssb-Index-RSRP, ssb-Index-SINR), and other channel state information, such as at least rank indicator (RI), channel quality indicator (CQI), precoding matrix indicator (PMI), Layer Index (LI), and/or the like.

The WTRU 200 may measure and report the channel state information (CSI), wherein the CSI for each connection mode may include or be configured with one or more of following:
CSI Report Configuration, including one or more of the following:
   CSI report quantity, e.g., Channel Quality Indicator (CQI), Rank Indicator (RI), Precoding Matrix Indicator (PMI), CSI-RS Resource Indicator (CRI), Layer Indicator (LI), etc.
   CSI report type, e.g., aperiodic, semi persistent, periodic.
   CSI report codebook configuration, e.g., Type I, Type II, Type II port selection, etc.
   CSI report frequency.
CSI-RS Resource Set, including one or more of the following CSI Resource settings
   NZP-CSI-RS Resource for channel measurement
   NZP-CSI-RS Resource for interference measurement
   CSI-IM Resource for interference measurement
NZP CSI-RS Resources, including one or more of the following
   NZP CSI-RS Resource ID
   Periodicity and offset
   QCL Info and TCI-state
   Resource mapping, e.g., number of ports, density, CDM type, etc.

The WTRU 200 may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The WTRU 200 may monitor, receive, or attempt to decode an SSB during initial access, initial synchronization, radio link monitoring (RLM), cell search, cell switching, and so forth.

The WTRU 200 may indicate, determine, or be configured with one or more reference signals. The WTRU 200 may monitor, receive, and measure one or more parameters based on the respective reference signals. For example, one or more of the following may apply. The following parameters are non-limiting examples of the parameters that may be included in reference signal(s) measurements. Other parameters may be included.
SS-RSRP. SS reference signal received power (SS-RSRP) may be measured based on the synchronization signals (e.g., demodulation reference signal (DMRS) in PBCH or SSS). It may be defined as the linear average over the power contribution of the resource elements (RE) that carry the respective synchronization signal. In measuring the RSRP, power scaling for the reference signals may be required. In case SS-RSRP is used for L1-RSRP, the measurement may be accomplished based on CSI reference signals in addition to the synchronization signals.
CSI-RSRP. CSI-RSRP may be measured based on the linear average over the power contribution of the resource elements (RE) that carry the respective CSI-RS. The CSI-RSRP measurement may be configured within measurement resources for the configured CSI-RS occasions.
SS-SINR. SS signal-to-noise and interference ration (SS-SINR) may be measured based on the synchronization signals (e.g., DMRS in PBCH or SSS). It may be defined as the linear average over the power contribution of the resource elements (RE) that carry the respective synchronization signal divided by the linear average of the noise and interference power contribution. In case SS-SINR is used for L1-SINR, the noise and interference power measurement may be accomplished based on resources configured by higher layers.
CSI-SINR. CSI-SINR may be measured based on the linear average over the power contribution of the resource elements (RE) that carry the respective CSI-RS divided by the linear average of the noise and interference power contribution. In case CSI-SINR is used for L1-SINR, the noise and interference power measurement may be accomplished based on resources configured by higher layers. Otherwise, the noise and interference power may be measured based on the resources that carry the respective CSI-RS.
RSSI. Received signal strength indicator (RSSI) may be measured based on the average of the total power contribution in configured OFDM symbols and bandwidth. The power contribution may be received from different resources (e.g., co-channel serving and non-serving cells, adjacent channel interference, thermal noise, and so forth).
CLI-RSSI. Cross-Layer interference received signal strength indicator (CLI-RSSI) may be measured based on the average of the total power contribution in configured OFDM symbols of the configured time and frequency resources. The power contribution may be received from different resources (e.g., cross-layer interference, co-channel serving and non-serving cells, adjacent channel interference, thermal noise, and so forth).
SRS-RSRP. Sounding reference signals RSRP (SRS-RSRP) may be measured based on the linear average over the power contribution of the resource elements (RE) that carry the respective SRS.
SS-RSRQ. Secondary synchronization signal reference signal received quality (SS-RSRQ) may be measured based on measurements on the reference signal received power (SS-RSRP) and received signal strength (RSSI). The SS-RSRQ may be calculated as the ratio of N×SS-RSRP/NR carrier RSSI, where N may be determined based on the number of resource blocks that are in the corresponding NR carrier RSSI measurement bandwidth. As such, the measurements to be used in the numerator and denominator may be over the same set of resource blocks.
CSI-RSRQ. CSI reference signal received quality (CSI-RSRQ) may be measured based on measurements on the reference signal received power (CSI-RSRP) and received signal strength (RSSI). The SS-RSRQ may be calculated as the ratio of N×CSI-RSRP/CSIRSSI, where N may be determined based on the number of resource blocks that are in the corresponding CSI-RSSI measurement bandwidth. As such, the measurements to be used in the numerator and denominator may be over the same set of resource blocks.

The WTRU 200 may be configured with one or more of the following in a CSI-RS Resource. A CSI-RS Resource Set (e.g., NZP-CSI-RS-ResourceSet) may include one or more of CSI-RS resources (e.g., NZP-CSI-RS-Resource and CSI-ResourceConfig).
CSI-RS periodicity and slot offset for periodic and semi-persistent CSI-RS Resources.
CSI-RS resource mapping to define the number of CSI-RS ports, density, CDM-type, OFDM symbol, and subcarrier occupancy.
The bandwidth part to which the configured CSI-RS is allocated.
The reference to the TCI-State including the QCL source RS(s) and the corresponding QCL type(s).

The WTRU 200 may be configured with one or more RS resource sets. The RS resource set configuration may include one or more of following: RS resource set ID, one or more RS resources for the RS resource set, repetition (i.e., on or off), aperiodic triggering offset (e.g., one of 0-6 slots), TRS info (e.g., true or not), etc. The WTRU 200 may be configured with one or more of the following RS resources: RS resource ID, Resource mapping (e.g., REs in a PRB), power control offset (e.g., one value of −8, . . . , 15), power control offset with SS (e.g., −3 dB, 0 dB, 3 dB, 6 Db), scrambling ID, periodicity and offset, QCL information (e.g., based on a TCI state).

In the following, an indication by DCI may consist of at least one of the following: (i) an explicit indication by a DCI field or by RNTI used to mask or scramble the CRC of the DCI; and/or an implicit indication by a property such as DCI format, DCI size, Coreset or search space, Aggregation Level, first resource element of the received DCI (e.g., index of first Control Channel Element), where the mapping between the property and the value may be signaled by RRC or MAC. Receiving or monitoring for a DCI with or using an RNTI may mean that the CRC of the DCI is masked or scrambled with the RNTI. Further, a signal may be interchangeably used with one or more of following: sounding reference signal (SRS), Channel state information - reference signal (CSI-RS), demodulation reference signal (DM-RS), phase tracking reference signal (PT-RS), and/or synchronization signal block (SSB). In addition, a signal, channel, and message (e.g., as in DL or UL signal, channel, and message) may be used interchangeably, but still consistent with this invention; a RS may be interchangeably used with one or more of RS resource, RS resource set, RS port and RS port group; a RS may be interchangeably used with one or more of SSB, CSI-RS, SRS, and DM-RS, TRS, PRS, and PTRS; a time instance, slot, symbol, and subframe may be used interchangeably; SSB, SS/PBCH block, PSS, SSS, PBCH, and MIB may be used interchangeably; the proposed solutions for beam resources prediction may be used for beam resources belonging to a single or multiple cells as well as single or multiple TRPs; CSI reporting may be interchangeably used with CSI measurement, beam reporting and beam measurement; and a RS resource set may be interchangeably used with a beam group.

The WTRU 200 may indicate its capability of supporting LP-WUS. The WTRU 200 may indicate supported signal structure types. For example, the WTRU 200 may indicate a first signal structure type (e.g., a set of configurations including one or more of whether to support preamble, preamble length (if supported). The WTRU 200 may indicate supported waveforms. For example, the WTRU 200 may indicate one or more of OOK-1, OOK-2, OOK-3, OOK-4, FSK-1, FSK-2, OFDMA and etc. The WTRU 200 may indicate whether to support LP-SS and/or minimum configuration of LP-SS. For example, the WTRU 200 may indicate required density, periodicity and etc. of LP-SS.

The WTRU 200 may indicate whether to support NR-SS and/or minimum configuration of NR-SS. For example, the WTRU 200 may indicate required density, periodicity and etc. of NR-SS. The WTRU 200 may indicate required activation time. The indication may be per signal structure type and/or supported waveform. For example, the WTRU 200 may indicate activation time for each structure type and/or each waveform. The WTRU 200 may also indicate activation time between different structure types and/or different waveforms. For example, the WTRU 200 may indicate first activation time for switching between same structure types/waveforms and second activation time(s) for switching between different structure types/waveforms.

The WTRU 200 may indicate minimal preamble length. The indication may be per signal structure type and/or supported waveform. For example, the WTRU 200 may indicate minimal preamble length for each structure type and/or each waveform. The WTRU 200 may indicate whether the WTRU 200 support timing cumulation during its off state. Based on the indication, the WTRU 200 may apply different timing and/or configurations. For example, the WTRU 200 may apply a first activation time if the WTRU 200 supports timing cumulation. The WTRU 200 may apply a second activation time if the WTRU 200 does not support timing cumulation.

A WTRU may be considered as a relay for LP-WUS (or for WUS in general) when the WTRU 200 is configured to forward to another WTRU (a “remote WTRU” or WTRU 200) a LP-WUS intended to the remote WTRU. The Relay WTRU functionalities may include monitoring/receiving resources for another WTRU, i.e., using the configuration (resources, IDs) intended for the remote, detecting/identifying that the signal is intended to the other WTRU (e.g., by checking the WTRU ID or subgroup ID in the signal and/or based on the resource), prepare and transmit the signal to the remote WTRU e.g., as a copy of the original signal, or in another data, channel or format. The Relay WTRU may not be required to be a SL Relay or have any other functionality beyond relaying the LP-WUS. The Remote WTRU may not be required to be a SL Remote WTRU or have any other functionality beyond receiving LP-WUS from the Relay WTRU. The Relay WTRU may be called “LP-WUS relay WTRU”, “LP-Relay”, “Relay WTRU”, “WTRU-based LP-WUS transmitter” etc. interchangeably, and can be considered similarly as an assistant WTRU or an aggregated WTRU in cooperative communications or aggregated communications. The Remote WTRU may be called “LP-WUS remoteWTRU”, “LP-Remote”, “Remote WTRU” etc. interchangeably, and can be considered similarly as an assisted WTRU or an aggregated WTRU in cooperative communications or aggregated communications. The Relay and Remote WTRUs may communicate with each other using various communication systems and resources, for example but not limited, using UL resources, PC5/SL resources when PC5/SL connection is available, dedicated proprietary links/channels. Etc.

The WTRU 200 (e.g., a remote WTRU) may configured with two sets of LP-WUS monitoring configurations, one for monitoring LP-WUS from the network and one for monitoring LP-WUS from another (relay) WTRU. The WTRU 200 may evaluate the conditions to monitor the LP-WUS from a relay WTRU, e.g., based on measurements above a threshold and after a first network-based exit condition was reached or if network-based entry conditions were not met. The WTRU 200 may monitor for or receive a wake-up indication and determine the PDCCH resource to monitor based on the LP-WUS source, e.g., using the first or second resource mapping.

The WTRU 200 may send its capabilities about LP-WUS monitoring to the network, e.g., using RRC or MAC indications. The network can then configure the WTRU 200 to perform LP-WUS monitoring and/or relayed LP-WUS monitoring based on the capabilities. The WTRU 200 may indicate that it supports the LP-WUs relaying, how many WTRUs can be relaying the LP-WUS, capability of simultaneous network-based and WTRU-based LP-WUs monitoring. The WTRU 200 may indicate the types of resources where it is capable of monitoring relayed LP-WUS. E.g., whether the WTRU supports the monitoring over UL resources, SL resources etc. The WTRU 200 may indicate to support OOK-based or OFDM-based or other types of relayed LP-WUS. The WTRU 200 may indicate one or more minimum timing between LP-WUS and PO monitoring, where timing may be different for relayed and network-based LP-WUS.

The WTRU 200 may receive a DRX configuration that may include a WTRU ID, paging related configuration (e.g., including the PDCCH resources, periodicity etc.), PEI related configuration, and subgroup ID(s). The WTRU 200 may also receive a first LP-WUS configuration (e.g., from the network, using one or more of SIB, RRC, MAC or DCI-based configuration). The first LP-WUS configuration, for LP-WUS monitoring from the network, may include one or more of: Entry/Exit conditions, e.g., measurements configuration and thresholds to enable and disable LP-WUS monitoring, LP-WUS occasions (LOs) and LP-WUS monitoring occasions (MOs), e.g., including associated time/frequency resources, repetitions, signal structure, sequence IDs, etc., the association between LO/PO and the corresponding Paging Occasions (POs), LP-WUS ID and/or LP-WUS subgroup ID, LP-SS resources, format, structure, etc.

The WTRU 200 may also receive a second LP-WUS configuration (e.g., from the network, using SIB, RRC, MAC or DCI-based configuration). The second LP-WUS configuration, for LP-WUS monitoring from another WTRU (e.g., a LP-relay), may also including one or more of: Entry/Exit conditions, e.g., measurements resources, configuration and thresholds to enable and disable LP-WUS monitoring, LP-WUS occasions (LOs) and LP-WUS monitoring occasions (MOs), e.g., including associated time/frequency resources, repetitions, signal structure, sequence IDs, etc., the association between LO/PO and the corresponding Paging Occasions (POs), LP-WUS ID and/or LP-WUS subgroup ID, LP-SS resources, format, structure, the LP relay WTRU ID. E.g., this may be explicitly indicated, or be part of other signaling, e.g., identification through LP-SS parameters, WUS parameters, WTRU-ID based LP-WUS resource, etc.

The LP-WUS from the first and second configuration may have some common configuration, e.g., the same sequence ID, signal structure, waveform, subgroup IDs etc. The LP-WUS from the first and second configuration mapping between LO/MO to PO resources may be different, e.g., the LO/MO resources of the first and second configuration targeting the same PO may be located on different time/frequency resources.

The LO/MO resources may be located in resources designated as DL (e.g., in a DL carrier/cell, DL time resource or DL sub-band) that the WTRU 200 is capable of monitoring. The LO/MO resources may also be located in resources dedicated to LP-WUS monitoring, e.g., a dedicated carrier/cell, portions of carriers/cell dedicated to LP-WUS monitoring. The LO/MO resources may be located in resources designated as UL (e.g., in a UL carrier, UL time resource or UL sub-band) that the WTRU is capable of monitoring, e.g., similarly as SRS measurements. Further, the LO/MO resources may be located in resources dedicated to LP-WUS monitoring, e.g., a dedicated carrier/cell, portions of carriers/cell dedicated to LP-WUS monitoring. In addition, the LO/MO resources may be located in resources designated as SL (e.g., in a SL carrier/BWP, SL time resource/resource pool) that the WTRU 200 is capable/configured to monitor. The LO/MO resources may be located in resources that are not exclusively configured for a given duplexing direction. For example, evolutions of 5G or 6G may be defined without clear DL/UL, allowing having flexible duplexing, full duplexing, overlapping duplexing or resources dynamically configured to a given duplexing direction.

The second configuration of LP-WUS monitoring may include a LP-WUS based on other type of signal, e.g., reusing or repurposing an existing WTRU transmission and acting as a LP-WUS. For example, the WTRU 200 may be configured to monitor a UL RS (e.g., SRS, PT-RS, etc.), an UL short-signal/channel similar to RACH-like or short-PUCCH transmissions, and including the corresponding resources, waveform, signal structures, IDs, etc. required for the resource identification and monitoring.

The first and second LP-WUS monitoring configuration may have different entry/exit conditions, e.g., based on different signals and/or using different thresholds. For example, the first configuration may include as an entry condition a first MR threshold on MR measurement (e.g., based on CSI-RS/SSB measurement), and/or a first LR threshold on LR measurement (e.g., based on LP-SS or LP-WUS measurement) from the network. The second configuration may include as an entry condition a second MR threshold on MR measurement (e.g., based on CSI-RS/SSB measurement), and/or a second LR threshold on LR measurement (e.g., based on LP-SS or LP-WUS measurement) from the network and/or a measurement threshold, e.g., based on SRS measurement (e.g. SRS-RSRP) or SL measurement (e.g. SL-RSRP).

The first configuration may include as an exit condition a first LR threshold on LR measurement (e.g., based on LP-SS or LP-WUS measurement) from the network. The second configuration may include as exit condition a second LR threshold on LR measurement (e.g., based on LP-SS or LP-WUS measurement) from the network. The difference between the first and the second threshold may be a (pre)configured offset.

The WTRU 200 may receive a configuration or message indicating the order or priority of the LP-WUS monitoring configuration to use, e.g., using the first configuration (from the network) as higher priority and the second configuration (from a LP-relay) as a second priority or fallback solution. In the case where multiple LP-relays are configured, e.g., in the case of multiple “second” LP-WUS monitoring configuration, the WTRU 200 may be configured with an order for each of them.

The WTRU 200 may indicate to the network that it activates, wants to activate or requests activation of the relayed LP-WUS, e.g., if the WTRU 200 is (pre)configured to have an indication. The WTRU 200 may activate/request/indicate a relayed LP-WUS when triggered by, e.g., low-battery level, traffic types, knowing the presence of compatible devices around (e.g., devices from a same set of devices, devices belonging to the same user, devices commonly managed (e.g., factory) etc. This activation may be indicated via RRC or MAC to let the network prepare the LP-WUS configuration.

The WTRU 200 may receive, from the network, an indication of whether the LP-WUS relaying is activated in the cell and/or for the WTRU 200 specifically, e.g., via SIB, RRC or MAC indication. The presence of relayed LP-WUS configuration may implicitly indicate the support and/or activation of the feature. The WTRU 200 may also be (pre)configured by the network with the relayed LP-WUS configuration but may further indicate to (de)activate the configuration, e.g., via RRC/MAC/DCI indication.

The WTRU 200 may evaluate the conditions to start monitoring LP-WUS, e.g., turning off the MR 202 and turning on the LR 204. One condition may relate to measurements based on the received LP-WUS monitoring configurations. The conditions may also include traffic requirements, RRC CONNECTED or IDLE/INACTIVE mode, minimum duration of inactivity, etc. For measurements, the WTRU 200 may perform the measurements on the configured resources and evaluate them against the associated thresholds for the first and second entry conditions. For example, the WTRU 200 may measure MR, e.g., based on SSB or CSI-RS measurements for the first condition, and SRS-RSRP for the second entry condition. The WTRU 200 may also be configured with LR-based measurements and perform a first measurement on network-based LP transmissions, e.g. on a first LP-SS resource and a second measurement on WTRU-based LP transmissions, e.g., on a second LP-SS resource, and evaluate them against the first and second LP thresholds, respectively.

The WTRU 200 may determine the LP-WUS monitoring configuration to use based on which entry condition(s) passed their respective criterions, and on the priority/order of mode of operation. For example, the WTRU 200 may receive the configuration indicating that the network-based LP-WUS monitoring is of higher priority, and the MR measurement passed the threshold for the entry condition. The WTRU 200 then determines to monitor the network-based LP-WUS, i.e., following the first set of configurations (LO/MO resources, LP-SS, format, etc.). Similarly, the WTRU 200 may receive the configuration indicating that the WTRU-based LP-WUS monitoring is of higher priority, and the measurement passed the threshold for the entry condition. The WTRU 200 then determines to monitor the WTRU-based LP-WUS, i.e., following the second set of configurations (LO/MO resources, LP-SS, format, etc.).

The WTRU 200 may receive a configuration indicating that the network-based LP-WUS monitoring is of higher priority, but the MR measurement does not pass the threshold for the entry condition, while the WTRU measurement passed the threshold for the entry condition. The WTRU 200 then determines to monitor the WTRU-based LP-WUS, i.e., following the second set of configurations (LO/MO resources, LP-SS, format, etc.). Similarly, the WTRU 200 may receive a configuration indicating that the WTRU-based LP-WUS monitoring is of higher priority, but the WTRU measurement does not pass the threshold for the entry condition, while the MR measurement passed the threshold for the entry condition. The WTRU 200 then determines to monitor the network-based LP-WUS, i.e., following the first set of configurations (LO/MO resources, LP-SS, format, etc.).

When the WTRU 200 receives multiple WTRU-based configurations (i.e., multiple LP-Relays), the WTRU 200 may evaluate them in order (if any is indicated) and select the one of highest priority satisfying the entry condition. If no priority/order is given, the WTRU 200 may select one relay randomly among the ones satisfying the entry condition, or select the one with the strongest signal quality on the WTRU 200 measurement. When none of the LP-WUS entry conditions is met (neither network-based not WTRU based), the WTRU 200 may keep the regular MR/DRX monitoring. The WTRU 200 may also indicate to the network that no entry condition was met, e.g., using RRC indication, RACH-based indication, SDT-based indication, etc. The network may use this indication to, for example, initiate a new LP-relay discovery procedure. When the entry conditions of multiple configurations are met, and if the WTRU 200 is capable, the WTRU 200 may monitor both network-based and WTRU-based LP-WUS, i.e., using both configurations.

The WTRU 200 may also determine the LP-WUS monitoring configuration to use as a result of a change in the behavior of the network-based exit conditions, e.g., as a fallback operation. For example, the WTRU 200 may monitor the network-based LP-WUS and may determine that the exit conditions are met (e.g., based on LP measurement being lower than the configured threshold). The WTRU 200 may evaluate entry/exit conditions based on the WTRU 200 measurements, and, if satisfied, may start monitoring WTRU-based LP-WUS (e.g., switching configuration).

The WTRU 200 may determine that the WFRU-based entry condition was met when evaluating the network-based entry condition (before turning off MR), and may switch to LR monitoring based on the second set of configurations (WTRU-based). This prevents the WTRU 200 to turn its MR 202 on for measurement purposes and saves energy. This may be conditioned to a max delay between the measurement and the evaluation, to estimate if the past measurement is still valid.

The WTRU 200 may use the second set of configurations directly, may perform measurements, and may evaluate the exit condition of WTRU-based LP-WUS monitoring, e.g., based on WTRU-based LP-SS, and if the exit condition is not met, the WTRU 200 may keep monitoring based on the second set of configurations (WTRU-based). The WTRU 200 may turn on its MR 202 and may perform measurements to evaluate entry conditions on the second set of configurations. If the conditions are satisfied, the WTRU 200 may turn off the MR 202 and start monitoring for a LP-WUS using the second set of configurations. This allows updated measurements but causes the WTRU 200 to wake up the MR 202 and consume energy. This may be conditioned to the previous measurement being outdated, e.g., based on a timer or max duration.

The WTRU 200 may monitor for a LP-WUS and may determine that the exit conditions are met (e.g., based on LP measurement being lower than the configured threshold). The WTRU 200 may evaluate the entry/exit conditions based on the network measurements, and, if satisfied, may start monitoring the network-based LP-WUS (e.g., switching configuration).

The WTRU 200 may evaluate that the network-based entry condition was met when evaluating the entry condition (before turning off MR) and may switch to LR monitoring based on the first set of configurations (network-based). This prevents the WTRU 200 to turn its MR 202 on for measurement purposes and saves energy. This may be conditioned to a max delay between the measurement and the evaluation, to estimate if the past measurement is still valid.

The WTRU 200 may use the first set of configurations directly, may perform measurements, and may evaluate the exit condition of network-based LP-WUS monitoring, e.g., based on network-based LP-SS. If the exit condition is not met, the WTRU 200 may keep monitoring the first set of configurations (network-based). The WTRU 200 may turn on its MR 202 and may perform network-based measurements to evaluate entry conditions on the second set of configurations. If the conditions are satisfied, the WTRU 200 may turn off the MR 202 and may start monitoring for a LP-WUS using the first set of configurations. This allows updated measurements but causes the WTRU 200 to wake up the MR 202 and consume energy. This may be conditioned to the previous measurement being outdated, e.g., based on a timer or max duration.

When the WTRU 200 is configured with multiple LP-WUS configurations (multiple LP-relays), the WTRU 200 may similarly evaluate the entry/exit condition of one or multiple other configurations and may switch to one of the configurations that satisfies the LP-WUS monitoring condition. When both the network-based LP-WUS monitoring conditions are not met (e.g., entry conditions not satisfied or exit condition satisfied), the WTRU 200 may stop LP-WUS monitoring and may fallback to turning on MR 202, e.g., and monitor the DRX-based resources. When the WTRU 200 is monitoring for multiple LP-WUS sources (e.g., from the network and from a LP-relay WTRU) and if one of them is reaching the exit condition, the WTRU 200 may stop monitoring the corresponding LP-WUS resources and may only monitor the remaining LP-WUS configuration.

The WTRU 200 may receive configuration information indicating when the WTRU 200 should send some report, e.g., reporting events. The WTRU 200 may receive the configuration information indicating which events to report and which not to report and may include resources configuration (e.g., based on UL RRC, MAC CE or UCI indications). In some examples, the WTRU 200 may not report to the network/WTRU the LP-WUS monitoring configuration, in which case the network blindly transmits the LP-WUS on the first set of resources and the LP-relay blindly monitors and forwards on the second set of resources.

The WTRU 200 may evaluate that: (i) the entry condition of the second LP-WUS monitoring configuration is met (e.g., when the SRS-RSRP or another WTRU measurement is higher than a threshold); (ii) the exit condition of the second LP-WUS monitoring configuration is met (e.g., when the LP-RSRP is lower than a threshold); and/or (iii) the exit condition of the first LP-WUS monitoring configuration is met (e.g., when the network-based LP-RSRP is lower than a threshold) and that the entry condition of the second LP-WUS monitoring configuration is met or that the exit condition of the second LP-WUS monitoring configuration is not met. The WTRU 200 may determine to change the LP-WUS monitoring source (e.g., switches from a first LP-WUS configuration to a second LP-WUS configuration). The WTRU 200 may determine to add or remove a LP-WUS monitoring source (e.g., start/stop monitoring using a first LP-WUS configuration or a second LP-WUS configuration).

When determining to monitor LP-WUS from a LP-relay, the WTRU 200 may send an indication to the network and/or to the LP-relay WTRU. This information may be used by the network and/or the LP-relay WTRU to determine which mode of operation the WTRU 200 is using and on which resource it will be monitoring, in particular, the need for the LP-relay to start relaying if it was not doing so. For example, the indication may include which LP-relay configuration to use, e.g., based on a configuration index or based on the WTRU-ID of the LP-relay. The indication may also include the reason why the WTRU 200 selected that LP-relay (e.g., the corresponding measurement value for WTRU 200 measurement) or may indicate that network-based exit condition has been met. The indication may be sent to the network, e.g., before the WTRU 200 turns off the MR 202, using RRC/MAC/UCI indication when in RRC CONNECTED mode. The WTRU 200 may use a RACH-based or SDT indication when in RRC IDLE/INACTIVE mode.

When the WTRU 200 is in IDLE/INACTIVE mode, the WTRU 200 may also switch to RRC CONNECTED to perform the indication. The indication may be sent to the relay WTRU before the WTRU 200 turns off the MR or if the WTRU 200 has a dedicated radio independent with Uu, such as a dedicated SL/PC5 radio. The indication may use the form of a (pre)configured resource on which the WTRU 200 may perform a transmission, e.g., an UL resource, a SL resource or a resource that may be used for both UL/DL depending on dynamic indications. The WTRU 200 may receive a SRS configuration to transmit on specific SRS resources, indicating that the WTRU 200 will start monitoring the LP-relay. In some examples, a new signal can be designed to perform short indications between WTRUs. In other examples, the WTRU 200 may use PC5/SL-based indications.

When determining to stop monitoring the LP-WUS from a LP-relay, the WTRU 200 may send an indication to the network and/or to the LP-relay WTRU. This information may be used by the network and the LP-relay WTRU to determining which mode of operation the WTRU 200 is using and on which resource it will be monitoring, in particular, that a LP-relay WTRU may stop relaying. The WTRU 200 may be triggered to send the indication when the corresponding exit condition was met and the WTRU 200 stopped monitoring the LP-relay, or if the WTRU 200 received indication to wake up its MR, e.g. received a LP-WUS or having some UL traffic to send.

When the WTRU 200 determine to use the LP-WUS monitoring (i.e., using a LR relay), the WTRU 200 may use the received second set of configurations. The WTRU 200 may monitor the LP-SS on the second set of LP-SS resources, to synchronize with the LP-relay. The WTRU 200 may also monitor the LP-WUS on the second set of resources for LOs/MOs. For example, the WTRU 200 may receive a configuration indication that the different LOs may be associated with one or more of the LP-SS(s) sent by the LP-relay.

The WTRU 200 may monitor the LP-WUS on Uu resources, e.g., UL resources on which the LP-relay WTRU may transmit a signal. The WTRU-based LP-WUS is the same as network-based LP-WUS, e.g., OOK-based or OFDM-based signals. The WTRU-based LP-WUS may be based on a different signal design, or reuse existing signal such as an UL RS (SRS, PT-RS, DMRS, etc.).

The WTRU 200 may monitor the LP-WUS on SL resources, if the WTRU s are capable of SL transmissions. The SL-based LP-WUS may be a unicast transmission if the WTRUs have an active SL connection, where the WTRU 200 may indicate SL IDs or use unicast SL resource reservation/configuration (e.g. semi-persistent/periodic transmissions). The SL-based LP-WUS may be a groupcast/broadcast transmission, using preconfigured SL resources on which the WTRU 200 may monitor for LP-WUS. The WTRU 200 may monitor both network-based and WTRU-based LP-WUS resources jointly, using both set of configurations.

While monitoring WTRU-based LP-WUS, the WTRU 200 maintains measurements to check and evaluate whether the exit conditions of the received LP-WUS monitoring configurations are met, to trigger a new determination of the mode of operation when a new condition is met. In some examples, the WTRU 200 may receive a LP-WUS indication in a monitored resource, may determine the resources to monitor on the MR (e.g., PDCCH for paging) and may wake-up its MR to monitor the determined resources. The WTRU 200 may consider a wake-up time (e.g., hardware requirements, time required for synchronizing the MR etc.) to be ready for reception on the determined resource.

The wake-up time may be different from based on the LP-WUS configuration (first vs second, network-based and LR-relay-based) used to monitor. The WTRU 200 may determine to wake-up its MR to monitor PDCCH based on the received indication in the monitored LP-WUS. For instance, the WTRU 200 may be configured with a same or different WTRU-ID or subgroup ID for the different LP-WUS monitoring configurations. Thus, the WTRU 200 may verify the presence of its configured WTRU/subgroup ID based on which resource (i.e., based on which corresponding configuration) it received the LP-WUS. The WTRU 200 may determine the PDCCH resource to monitor based on which resource (i.e., based on which corresponding configuration) it received the LP-WUS. In some examples:

The WTRU 200 may have received a first LO/MO to PO mapping for a first LP-WUS configuration (e.g., from the network) and a second LO/MO to PO mapping for a second LP-WUS configuration (e.g., from the LP-relay). When the WTRU 200 receives the LP-WUS using the first LP-WUS configuration, the WTRU 200 determines the PO resource to monitor based on the first mapping. When the WTRU 200 receives the LP-WUS using the second LP-WUS configuration, the WTRU 200 determines the PO resource to monitor based on the second mapping.

The WTRU 200 may receive a first LO/MO to PO mapping for a first LP-WUS configuration (e.g., from the network) and a second LO/MO to PO mapping for the same first LP-WUS configuration (e.g., from the network), to be used when the WTRU 200 monitors from both network and LP-relay based configurations. The reason being that when the network is aware that the WTRU 200 monitors a LP-relay, e.g., based on the remote WTRU transmitting the report/indication, the network may use a different mapping between the LO/MO it transmits and the PO, so that the LP-relay may have time to receive and forward to the remote. When the WTRU 200 receives the LP-WUS using the first LP-WUS configuration (network-based) and if the WTRU 200 did not indicate to the network it monitors LP-relay (or if the WTRU 200 does not monitor from LP-relay), the WTRU 200 determines the PO resource to monitor based on the first mapping. When the WTRU 200 receives the LP-WUS using the first LP-WUS configuration (network-based) and if the WTRU 200 indicated to the network it monitors LP-relay (or if the WTRU 200 monitors from LP-relay), the WTRU 200 determines the PO resource to monitor based on the second mapping.

The WTRU 200 may determine the LO/MO resources to monitor based on the PO resources (e.g., based on the DRX configuration) and based on the PO to LO/MO mappings. As such, the PO timing may be (pre)configured, e.g., based on the DRX configuration, and the WTRU 200 may determine the LP-WUS monitoring resource corresponding to each PO, the LO/MO time being before the PO. The WTRU 200 may determine the LO/MO to monitor using LR based on which corresponding configuration it uses for the LP-WUS monitoring.

The WTRU 200 may receive a first PO to LO/MO mapping for a first LP-WUS configuration (e.g., from the network) and a second PO to LO/MO mapping for a second LP-WUS configuration (e.g., from the LP-relay). When the WTRU 200 determines to use the first LP-WUS configuration, the WTRU 200 determines the LO/MO resource to monitor based on the first mapping. When the WTRU 200 determines to use the second LP-WUS configuration, the WTRU 200 may determine the LO/MO resource to monitor based on the second mapping.

The WTRU 200 may receive a first PO to LO/MO mapping for a first LP-WUS configuration (e.g., from the network) and a second PO to LO/MO mapping for the same first LP-WUS configuration (e.g., from the network), to be used when the WTRU 200 monitors from both network and LP-relay based configurations. The reason being that when the network is aware that the WTRU 200 monitors a LP-relay, e.g., based on the remote WTRU 200 transmitting the report/indication, the network may use a different mapping between the LO/MO it transmits and the PO, so that the LP-relay may have time to receive and forward to the remote. When the WTRU 200 determines to use only the first LP-WUS configuration, the WTRU 200 may determine the LO/MO resource to monitor based on the first mapping. When determining to use both the first and the second LP-WUS configurations (from network and LP-relay, the WTRU 200 determines the LO/MO resource to monitor based on the second mapping. When the WTRU 200 receives a LP-WUS with the corresponding ID/subgroup ID in either the first or second determined LO/MO, the WTRU 200 may determine to wake-up its MR to monitor the PO used to determine the LO/MO.

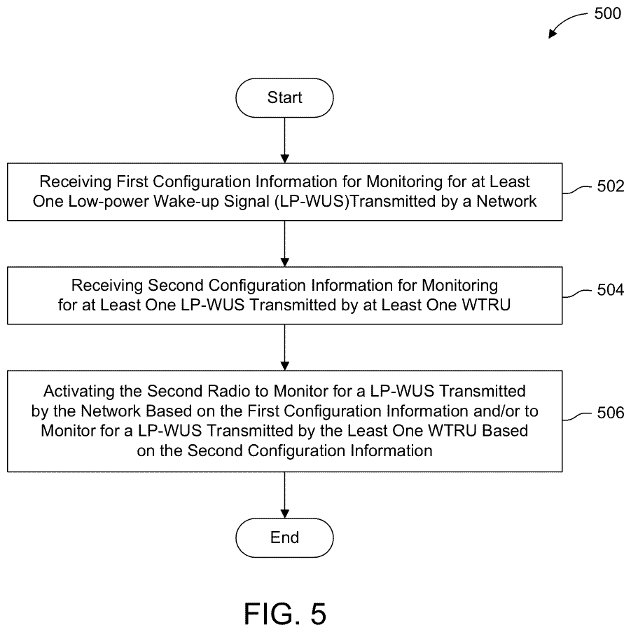

Referring now to FIG. 5, a flow diagram of a method 500 for extending coverage for low power signals is illustrated, according to an exemplary embodiment. The method 500 may be implemented by a WTRU (e.g., WTRU 200). The method 500 may involve enabling or activating a WTRU to extend its monitoring coverage for LP-WUSs. The WTRU may be configured with a first radio (e.g., a main radio or MR 202)) and a second radio (e.g., a low power radio or LR 204)). The method 500 may enable the WTRU 200 to monitor for LP-WUSs transmitted by a network and LP-WUSs transmitted by another WTRU, such as a relay WTRU. The WTRU may receive and be configured with two sets of LP-WUS monitoring configurations (e.g., entry/exit conditions, LO-PO mapping, etc.). The WTRU 200 may select/apply a LP-WUS monitoring configuration based on whether the WTRU monitors for a LP-WUS from another WTRU or network. For example, first configuration information may be used by the WTRU to monitor for a LP-WUS from a network and second configuration information may be used by the WTRU to monitor for a LP-WUS from another WTRU or a relay WTRU. As a result, power consumption of the WTRU may be reduced and the battery life of the WTRU may be extended.

At block 502, the method 500 may involve receiving first configuration information for monitoring for at least one LP-WUS transmitted by a network. For example, the WTRU may receive a first LP-WUS monitoring configuration. The first LP-WUS monitoring configuration may include an entry condition based on a MR measurement and/or LP measurement of a network transmitted signal, an exit condition based on a LR measurement of a network transmitted signal (e.g. LP-SS), a first set of LP-WUS monitoring resources, and a LP-WUS signal configuration (e.g., with a first LO/PO mapping, LP-SS, etc.).

At block 504, the method 500 may involve receiving second configuration information for monitoring for at least one LP-WUS transmitted by at least one WTRU. For example, the WTRU may receive a second LP-WUS monitoring configuration. The second LP-WUS configuration may include an entry condition based on a WTRU measurement (e.g. SRS-RSRP, SL-RSRP, etc.) and/or a LP measurement based on UE transmitted signal, an exit condition based on a LR measurement of a WTRU transmitted LP signal, a second set of LP-WUS monitoring resources, and a LP-WUS signal configuration (e.g., with a second LO/PO mapping, LP-SS, etc.).

At block 506, the method 500 may involve activating the second radio (e.g., LR 204) to monitor for a LP-WUS transmitted by the network based on the first configuration information and/or to monitor for a LP-WUS transmitted by the least one WTRU based on the second configuration information. For example, the WTRU may activate or enable LP-WUS monitoring for signals from a network and/or another WTRU (e.g., a relay WTRU) and may turn off the MR 202. The WTRU may perform measurements for entry and/or exit conditions based on first and second configuration information. For example, the WTRU may be configured with entry and/or exit conditions for LP-WUS monitoring in RRC mode in an IDLE/INACTIVE state.

The WTRU may receive, via a main radio (MR) one or more reference or a download (DL) signals from a network or base station. The WTRU may measure the one or more of the reference signal (RSs) received by the MR (e.g., MR measurement) and/or the LR (e.g., a LR measurement). The WTRU may determine whether the MR measurement is larger than a MR entry threshold of the first configuration information. If the MR measurement is larger than a MR entry threshold, the WTRU may monitor, via the LR, for a LP-WUS from the network based on the first configuration information. The WTRU may also stop or discontinue PO monitoring via the MR. The WTRU may also determine whether the LR measurement is larger than a LR entry threshold of the first configuration information. If the LR measurement is larger than the LR entry threshold, the WTRU may monitor for a LP-WUS from the network via the LR based on the first configuration information. The WTRU may also stop or discontinue PO monitoring via the MR.

The WTRU may also receive one or more signals from the at least one WTRU (e.g., one or more relay WTRUs). The WTRU may measure the one or more signals received by the MR 202 (e.g., a MR measurement) and/or the LR 204 (e.g., a LR measurement). The WTRU may determine whether the MR measurement is larger than a first MR entry threshold of the second configuration information. If the MR measurement is larger than the first MR entry threshold of the second configuration information, the WTRU may monitor for a LP-WUS from the at least one WTRU (e.g., a relay WTRU) via the LR 204 based on the second configuration information. The WTRU may also stop or discontinue PO monitoring via the MR 202. The WTRU may also determine whether the LR measurement is larger than a LR entry threshold of the second configuration information. If the LR measurement is larger than the LR entry threshold of the second configuration information, the WTRU may monitor, via the LR, for a LP-WUS from the at least one WTRU (e.g., a relay WTRU) based on the second configuration information. The WTRU may also stop or discontinue PO monitoring via the MR 202

In some examples, the WTRU may monitor for a LP-WUS using the second set of resources (i.e., from the LP-Relay WTRU) based on one or more of the following conditions: a first exit condition is met (e.g., network LR measurement is below its configured threshold), a first entry condition(s) is not met (e.g., network MR measurement is below its configured threshold), and a second entry condition is met (e.g., UE-based measurements is above its configured threshold). On the condition that the WTRU uses LP-Relay based monitoring, the WTRU may send an indication to the network for activating LP-Relay based LP monitoring.

While the WTRU is monitoring for a LP-WUS from the network, the WTRU may perform measurements to determine whether to exit or stop monitoring for the LP-WUS based on the first configuration information. For example, the WTRU may receive one or more reference signals (RSs) or download signals from the network. The WTRU may measure the one or more RSs received by the MR (e.g., a MR measurement) and/or the LR (e.g., a LR measurement). The WTRU may determine whether a MR measurement is lower than a MR exit threshold of the first configuration information. If the MR measurement is lower than the MR exit threshold, the WTRU may stop or discontinue the monitoring for a LP-WUS from the network and monitor for a PO via the MR. The WTRU may also determine whether the LR measurement is below a LR exit threshold (e.g., out of coverage) of the first configuration information. If the LR measurement is below the LR exit threshold (e.g., out of coverage), the WTRU may stop or discontinue the monitoring for a LP-WUS from the network via the LR and monitor for a PO via the MR. When a LP-WUS is received using the first configuration information, the WTRU may use LO/MO-PO mapping of the first configuration information to determine the PO resources. For example, in the case of the reception of a LP-WUS from the network, the WTRU may determine the PDCCH/PO resource to monitor, wake-up the MR 202, and monitor the corresponding paging occasion.

The WTRU may also perform measurements to determine whether to exit or stop monitoring for the LP-WUS from the at least one WTRU (e.g., one or more relay WTRUs) based on the second configuration information. For example, the WTRU may receive one or more signals from the at least one WTRU (e.g., a relay WTRU). The WTRU may measure the one or more signal received by the MR (e.g., a MR measurement) and/or the LR (e.g., a LR measurement). The WTRU may determine whether the MR measurement is lower than a MR exit threshold of the second configuration information. If the MR measurement is lower than the MR exit threshold of the second confirmation information, the WTRU may stop or discontinue the monitoring for a LP-WUS from the at least one WTRU via the LR and may monitor for a PO via the MR. The WTRU may also determine whether the LR measurement is below a LR exit threshold (e.g., out of coverage) of the second configuration information. If the LR measurement is below the LR exit threshold (e.g., out of coverage) of the second configuration information, the WTRU may stop or discontinue the monitoring for a LP-WUS from the at least one WTRU via the LR and may monitor for a PO via the MR. The WTRU may also send an indication to the network for activating and/or deactivating LP-Relay based LP monitoring. When a LP-WUS is received or detected using the second configuration information, the WTRU may use the LO/MO-PO mapping of the second confirmation information to determine the PO resources. For example, in the case of the reception of a LP-WUS from the at least one WTRU (e.g., relay WTRU), the WTRU may determine the PDCCH/PO resource to monitor, wake-up the MR 2020, and monitor the corresponding Paging occasion.

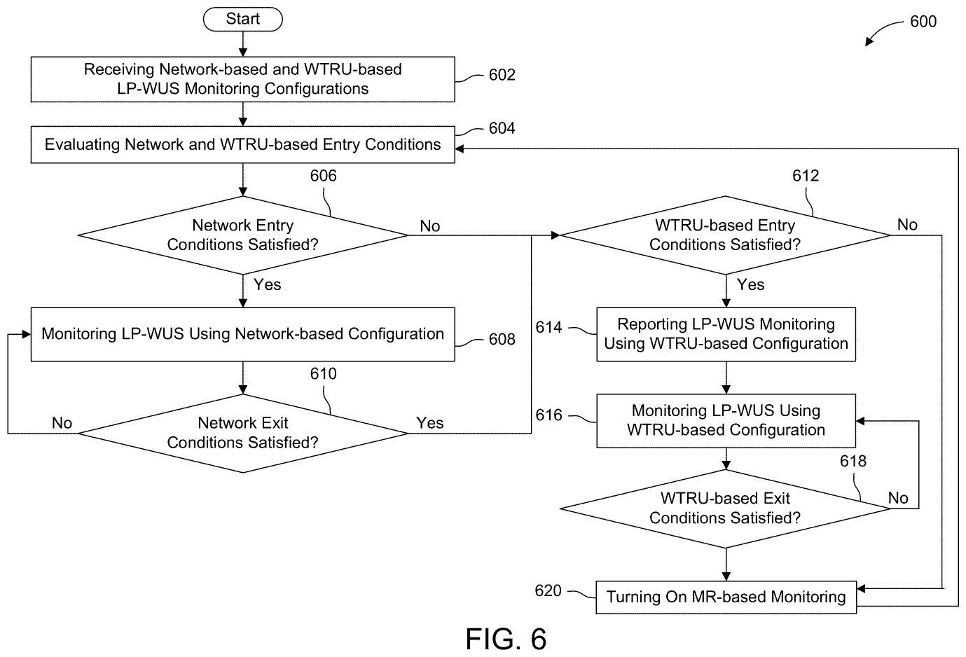

Referring now to FIG. 6, a flow diagram of a method 600 is illustrated for measurements for extending cover age for low power signals, according to another exemplary embodiment. The method 600 may be implemented by a WTRU (e.g., WTRU 200). The method 600 may enable a WTRU to extend its monitoring coverage for LP-WUSs. The WTRU may be configured with a first radio (e.g., a main radio or MR 202)) and a second radio (e.g., a low power radio or LR 204)). The method 600 may enable the WTRU to monitor for LP-WUSs transmitted by a network and LP-WUSs transmitted by another WTRU, such as a relay WTRU. The WTRU may be configured with two sets of LP-WUS monitoring conditions or configurations (e.g., entry/exit conditions, LO-PO mapping), such as a network-based and a WTRU-based LP-WUS monitoring conditions. The WTRU may select/apply a monitoring configuration based on whether the WTRU receives or monitors for a LP-WUS from a network or another WTRU. For example, the network-based LP-WUS monitoring configuration may be used by the WTRU to monitor for a LP-WUS from the network and the WTRU-based LP-WUS monitoring conditions may be used by the WTRU to monitor for a LP-WUS from another WTRU or relay WTRU. As a result, power consumption of the WTRU may be reduced and the battery life of the WTRU may be extended.

At block 602, the method 600 may involve receiving network-based and WTRU-based LP-WUS Monitoring conditions or configurations. For example, the WTRU may receive network-based LP-WUS monitoring condition or configuration. The network-based LP-WUS monitoring condition may include an entry condition based on a MR measurement and/or a LP measurement of a network transmitted signal, an exit condition based on a LR measurement of a network transmitted signal (e.g. LP-SS), a first set of LP-WUS monitoring resources, and a LP-WUS signal configuration (e.g., with a first LO/PO mapping, LP-SS, etc.). The WTRU may also receive a WTRU-based LP-WUS monitoring condition or configuration. The WTRU-based LP-WUS monitoring configuration may include an entry condition based on a MR measurement and/or a LP measurement of a relay WTRU transmitted signal, an exit condition based on a LR measurement of a relay WTRU transmitted signal (e.g. LP-SS), a first set of LP-WUS monitoring resources, and a LP-WUS signal configuration (e.g., with a first LO/PO mapping, LP-SS, etc.).

At block 604, the method 600 may involve evaluating network and WTRU-based entry conditions. The WTRU may perform measurements for the entry conditions based on the network-based and WTRU-based LP-WUS Monitoring configurations. For example, the WTRU may be configured with entry and/or exit conditions for LP-WUS monitoring in RRC mode in an IDLE/INACTIVE state.

At block 606, the method 600 may involve determining whether entry conditions of the network-based LP-WUS monitoring configuration are satisfied. For example, the WTRU may receive one or more reference or a download (DL) signals from a network or base station. The WTRU may measure the one or more of the reference signal (RSs) received by the MR (e.g., a MR measurement) and/or the LR (e.g., a LR measurement). The WTRU may determine whether the MR measurement satisfies a MR entry threshold of a network-based LP-WUS monitoring condition. If the MR measurement satisfies the MR entry threshold, the WTRU may monitor for a LP-WUS from the network via the LR based on the network-based LP-WUS monitoring configuration. The WTRU may also stop or discontinue PO monitoring via the MR. The WTRU may also determine whether the LR measurement satisfies a LR entry threshold of the network-based LP-WUS monitoring configuration. If the LR measurement satisfies the LR entry threshold, the WTRU may monitor for a LP-WUS from the network via the LR based on the network-based LP-WUS monitoring configuration. The WTRU may also stop or discontinue PO monitoring via the MR.

At block 608, the method 600 may involve monitoring for LP-WUS using the network-based LP-WUS monitoring configuration when a network-based entry condition is satisfied. At block 610, the method 600 may involve determining whether the exit conditions of the network-based LP-WUS monitoring configuration are satisfied. The WTRU may perform measurements to determine whether to exit or stop monitoring for the LP-WUS based on the network-based LP-WUS monitoring configuration. For example, the WTRU may receive one or more reference signals (RSs) or download signals from the network. The WTRU may measure the one or more RSs received by the MR (e.g., a MR measurement) and/or the LR (e.g., a LR measurement). The WTRU may determine whether the MR measurement satisfies a MR exit threshold of the network-based LP-WUS monitoring configuration. If the MR measurement satisfies the MR exit threshold, the WTRU may stop or discontinue the monitoring for a LP-WUS from the network and monitor for a PO via the MR and proceed to block 612. The WTRU may also determine whether the LR measurement satisfies a LR exit threshold (e.g., out of coverage) of the network-based LP-WUS monitoring configuration. If the LR measurement satisfies a LR exit threshold (e.g., out of coverage), the WTRU may stop or discontinue monitoring for a LP-WUS from the network via the LR and monitor for a PO via the MR and proceed to block 612. When a LP-WUS is received using the network-based LP-WUS monitoring conditions or configuration, the WTRU may use LO/MO-PO mapping of the network-based LP-WUS monitoring configuration to determine the PO resources. For example, in the case of the reception of a LP-WUS from the network, the WTRU may determine the PDCCH/PO resource to monitor, wake-up the MR, and monitor the corresponding paging occasion. When exit conditions of the network-based LP-WUS monitoring configuration are not satisfied at block 610, the method 600 may proceed to block 608.

When the network-based exit conditions are satisfied at block 610, the method 600 may involves determining whether the entry conditions of the WTRU-based LP-WUS monitoring configuration or conditions are satisfied at block 612. The WTRU may receive one or more signals from the at least one WTRU (e.g., one or more relay WTRUs). The WTRU may measure the one or more signals received by the MR (e.g., a MR measurement) and/or the LR (e.g., a LR measurement). The WTRU may determine whether the MR measurement satisfies a MR entry threshold of the WTRU-based LP-WUS monitoring configuration. If the MR measurement satisfies the MR entry threshold of the WTRU-based LP-WUS monitoring configuration, the method 600 may involve reporting LP-WUS monitoring using the WTRU-based LP-WUS monitoring configuration at block 614. The WTRU may also determine whether the LR measurement satisfies a LR entry threshold of the WTRU-based LP-WUS monitoring configuration. If the LR measurement satisfies the LR entry threshold of the WTRU-based LP-WUS monitoring configuration, the WTRU may monitor for a LP-WUS from the at least one WTRU (e.g., a relay WTRU) via the LR based on the WTRU-based LP-WUS monitoring configuration. The WTRU may also stop or discontinue PO monitoring via the MR.

At block 616, the method may involve monitoring for a LP-WUS using the WTRU-based LP-WUS monitoring configuration. For example, the WTRU may monitor for a LP-WUS from the at least one WTRU (e.g., a relay WTRU) via the LR using the WTRU-based LP-WUS monitoring configuration. At block 618, the method 600 may involve determining whether the exits conditions of the WTRU-based LP-WUS monitoring configuration are satisfied. If the WTRU-based exit conditions are not satisfied at block 618, the method 600 may proceed to block 616.

The WTRU may perform measurement to determine whether to exit or stop monitoring for the LP-WUS from the at least one WTRU (e.g., one or more relay WTRU) based on the WTRU-based LP-WUS monitoring configuration. For example, the WTRU may receive one or more signals from the at least one WTRU (e.g., a relay WTRU). The WTRU may measure the one or more signal received by the MR (e.g., a MR measurement) and/or the LR (e.g., a LR measurement). The WTRU may determine whether the MR measurement satisfies a MR exit threshold of the WTRU-based LP-WUS monitoring configuration. If the MR measurement satisfies the MR exit threshold of the WTRU-based LP-WUS monitoring configuration, the WTRU may stop or discontinue the monitoring for a LP-WUS from the at least one WTRU via the LR. The WTRU may also turn-on MR based monitoring at block 620 to monitor for a PO via the MR and the method may proceed to block 604. The WTRU may also determine whether the LR measurement is below the LR exit threshold (e.g., out of coverage) of the WTRU-based LP-WUS monitoring configuration. If the LR measurement satisfies a LR exit threshold (e.g., out of coverage) of the WTRU-based LP-WUS monitoring configuration, the WTRU may stop or discontinue the monitoring for a LP-WUS from the at least one WTRU via the LR and may monitor for a PO via the MR. The WTRU may also turn-on MR based monitoring at block 620 to monitor for a PO via the MR and the method may proceed to block 604. The WTRU may also send an indication to the network for deactivating LP-Relay based LP monitoring. When a LP-WUS is received or detected using the WTRU-based LP-WUS monitoring configuration, the WTRU may use the LO/MO-PO mapping of the WTRU-based LP-WUS monitoring configuration to determine the PO resources. For example, in the case of the reception of a LP-WUS from the at least one WTRU (e.g., relay WTRU), the WTRU may determine the PDCCH/PO resource to monitor, wake-up the MR, and monitor the corresponding paging occasion.

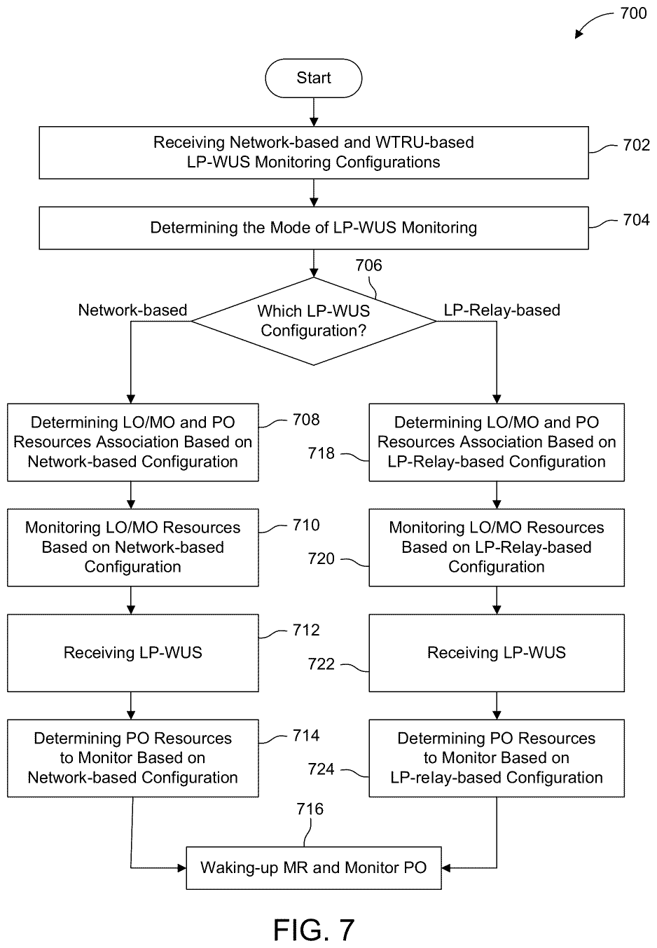

Referring now to FIG. 7, a flow diagram of a method 700 is illustrated for extending coverage for low power signal, according to another exemplary embodiment. The method 700 may be implemented by a WTRU (e.g., WTRU 200). The method 700 may enable a WTRU to extend its monitoring coverage for LP-WUSs. The WTRU may be configured with a first radio (e.g., a main radio or MR 202)) and a second radio (e.g., a low power radio or LR 204)). The method 600 may enable the WTRU to monitor for LP-WUSs transmitted by a network and LP-WUSs transmitted by another WTRU, such as a relay WTRU. The WTRU may be configured with two sets of LP-WUS monitoring conditions or configurations (e.g., entry/exit conditions, LO-PO mapping), such as a network-based and WTRU-based LP-WUS monitoring conditions or configuration. The WTRU may select/apply a monitoring configuration based on whether the WTRU receives or monitors for a LP-WUS from a network or another WTRU. For example, the network-based LP-WUS monitoring configuration may be used by the WTRU to monitor for a LP-WUS from a network and the WTRU-based LP-WUS monitoring configuration may be used by the WTRU to monitor for a LP-WUS from another WTRU or relay WTRU. As a result, power consumption of the WTRU may be reduced and the battery life of the WTRU may be extended.

At block 702, the method 700 may involve receiving network-based and WTRU-based LP-WUS Monitoring configurations or conditions. For example, the WTRU may receive a network-based LP-WUS monitoring configuration. The network-based LP-WUS monitoring configuration may include an entry condition based on a MR measurement and/or a LP measurement of a network transmitted signal, an exit condition based on a LR measurement of a network transmitted signal (e.g. LP-SS), a first set of LP-WUS monitoring resources, and a LP-WUS signal configuration (e.g., with a first LO/PO mapping, LP-SS, etc.). The WTRU may also receive a WTRU-based LP-WUS monitoring configuration. The WTRU-based LP-WUS monitoring configuration may include an entry condition based on a MR measurement and/or a LP measurement of a network transmitted signal, an exit condition based on a LR measurement of a network transmitted signal (e.g. LP-SS), a first set of LP-WUS monitoring resources, and LP-WUS signal configuration (e.g., with a first LO/PO mapping, LP-SS, etc.).

At block 704, the method 700 may involve determining the mode of LP-WUS monitoring. For example, the WTRU may activate or enable LP-WUS monitoring for signals from a network and/or another WTRU (e.g., a relay WTRU). At block 706, the method 700 may involve determining or selecting a LP-WUS configuration. For example, the WTRU may determine or select a network-based LP-WUS Monitoring configuration and/or a WTRU-based LP-WUS monitoring configuration.

When a network-based monitoring configuration is determined or selected at block 706, the method may involve determining LO/MO and PO resources association based on network-based LP-WUS monitoring configuration at block 708. At block 710, the method may involve monitoring LO/MO resources based on the network-based configuration. At block 712, the method may involve receiving the LP-WUS and determining PO resources to monitor based on the network-based LP-WUS monitoring configuration at block 714. At block 716, the method may involve waking-up MR and monitoring PO.

When a LP-relay based configuration is selected or determined at block 706, the method 700 may involve determining LO/MO and PO resources association based on LP-relay based configuration at block 718. At block 720, the method 700 may involve monitoring LO/MO resources based on LP-relay-based configuration. At block 722, the method may involve receiving the LP-WUS and determining PO resources to monitor based on the LP-relay based configuration at block 724. The method may proceed to block 716 where the method may involve waking-up MR and monitored PO.

Referring again to FIG. 2, the remote WTRU 200 may be configured with a second LP-WUS monitoring configuration from a LP-relay WTRU once (at least) one LP-Relay WTRU is identified as a suitable to relay the LP-WUS to the (remote) WTRU 200. To do so, the WTRU 200 may send a LP-relay discovery request, where the request is motivated/triggered by MR/LR-based measurements, e.g., triggered by the WTRU 200 reaching the Exit condition for LP-WUS monitoring or not reaching Entry conditions, while still being (well) under coverage of the MR. The WTRU 200 may find or discover a suitable LP-Relay before receiving the LP-Relay-based LP-WUS monitoring configuration as described above.

The WTRU 200 may receive a DRX configuration that may include a WTRU ID, a paging related configuration (e.g., including the PDCCH resources, periodicity etc.), PEI related configuration, subgroup ID(s). The WTRU 200 may receive a first LP-WUS configuration (e.g., from the network, using one or more of SIB, RRC, MAC or DCI-based configuration). The first LP-WUS configuration, for LP-WUS monitoring from the network, may include one or more of: Entry/Exit conditions, e.g., measurements configuration and thresholds to enable and disable LP-WUS monitoring, LP-WUS occasions (LOs) and LP-WUS monitoring occasions (MOs), e.g., including associated time/frequency resources, repetitions, signal structure, sequence IDs, etc., the association between LO/PO and the corresponding Paging Occasions (POs), LP-WUS ID and/or LP-WUS subgroup ID, LP-SS resources, format, structure, etc.

The WTRU 200 may receive a configuration enabling LP-WUS relaying, e.g., based on the reported capabilities. The triggering configuration to request/initiate the discovery procedure may be one or more of, for example: The WTRU 200 may receive a configuration including thresholds based on MR-based measurements and/or LR-based measurements to trigger the discovery request. For instance, the WTRU 200 may use the entry condition for LP-WUS monitoring and their associated thresholds as a trigger for the discovery request procedure, e.g., based on MR and/or LR measurements.

The WTRU 200 may receive the MR and/or LR measurements-based thresholds. The threshold may be different than the entry condition, e.g., explicitly received in the configuration or as an offset to the entry condition. The WTRU 200 may use the exit condition for LP-WUS monitoring and their associated thresholds as trigger for the discovery request procedure, e.g., based on LR measurements. The WTRU 200 may receive LR measurements-based thresholds, the threshold may be different than the exit condition, e.g., explicitly received in the configuration or as an offset to the exit condition.

The WTRU 200 may be configured with a max number of LP-Relays and, when the number of the LP-relay based configuration is lower than the max, the WTRU 200 may trigger a LP-WUS discovery request. The WTRU 200 may be configured to request a LP-WUS relay discovery when its battery is low enough, e.g., lower than a threshold, or if the WTRU 200 is using a low-power/energy-efficient mode. Presence of other WTRU 200. The WTRU 200 may be configured to request LP-WUS relay discovery when it detects the presence of other WTRUs nearby, e.g., when the WTRU 200 receives SL/PC5 signals or established PC5/SL connections, when the WTRU 200 measured other WTRU 200 signals over a threshold, e.g., based on SRS measurement, etc.

The WTRU 200 may initiate the LP-relay discovery procedure based on one or more of the triggers: The WTRU 200 may trigger the discovery request procedure when one or more measurements, e.g., based on MR-based measurements and/or LR-based measurements. The WTRU 200 may trigger the discovery request procedure when the entry condition for LP-WUS monitoring is not met, e.g., the MR measurement is below the configured entry-condition threshold or the LR measurement is below the configured entry-condition threshold, if configured.

The WTRU 200 may also trigger the discovery request procedure when the exit condition for LP-WUS monitoring is met (WTRU 200 turning off LR), e.g., the LR measurement is below the configured exit-condition threshold. Further, the WTRU 200 may trigger the discovery request procedure when a MR-based measurement is below a threshold, the threshold may be different than the entry condition. The WTRU 200 may trigger the discovery request procedure when a LR-based measurement is below a threshold, the threshold may be different than the exit condition. If the WTRU 200 does not have a configuration for LP-Relay or if it has less configurations than the max number of LP-Relay, the WTRU 200 may trigger the request for LP-Relay discovery. If the battery of the WTRU 200 is below the configured threshold, or if the WTRU 200 activates a low-power mode, the WTRU 200 may trigger the request for LP-Relay discovery. If the WTRU 200 detects the presence of other WTRUs, e.g., via WTRU 200 signal measurements over a configured threshold (e.g., SRS-RSRP), the WTRU 200 may trigger the request for LP-Relay discovery.

When the WTRU 200 is triggered by reaching an exit-condition or measurement based on LR, the WTRU 200 may wake-up the MR 202 to be able to perform the discovery procedure request. When triggered to initiate the LP-relay discovery procedure, the WTRU 200 may send a request/report to the network indicating that it requests LP-Relays. The request may sent using RRC configuration, MAC CE indication or PHY-level indication, e.g., based on the received configuration for request format. The WTRU 200 may use an indication in RACH procedure indicating the WTRU 200 discovery procedure.

The WTRU 200 may use a Short Message or SDT-based indicating the WTRU 200 discovery procedure. The communication may include one or more of the following types of information: Trigger condition, e.g., which measurement triggered the procedure and/or with the measurement value that triggered it, Max number of WTRU 200 that the WTRU 200 request as LP-Relay, IDs of other WTRUs, or indication of other WTRUs that the WTRU 200 detected or knows the presence of, e.g., based on measurements or PC5 connections, Battery level or the usage of a low-power mode.

The WTRU 200 may receive measurements and reporting configuration for WTRU-based transmissions, e.g., the measurement resource, signal type and thresholds.

The WTRU 200 may receive configuration information and may perform LR-based measurements from other WTRUs, e.g., including the resources for monitoring LP-SS or LP-WUS sent by one or more users, the LP signal formats (OOK, OFMD, FSK, etc.), and any required LP configuration to be able to receive and measure properly the corresponding thresholds. In one example, the WTRU-based LP resources may be in UL resources, SL resource, dedicated LP resources or resources without assigned duplexing direction. The WTRU 200 may receive configuration information and may perform MR-based measurements from other WTRUs, e.g., including the (UL) resources for monitoring WTRU transmissions, such as WTRU-based RS (e.g. SRS, PT-RS, UL DMRS etc.), and any required configuration to be able to receive and measure properly (resources, format, comb, sequence index etc.) the corresponding thresholds.

The WTRU 200 may receive the configuration information and may perform SL-based measurements from other WTRUs, e.g., including the (SL) resources for monitoring WTRU transmissions, such as SL-RSSI, PSBCH-RSRP, PSSCH-RSRP, PSCCH-RSRP, or measurements based on SL RS (SL-SSB, SL-DMRS, etc.) and any required configuration to be able to receive and measure properly (resources, format, comb, sequence index etc.) the corresponding thresholds. The WTRU 200 may receive the configuration information and may measure/estimate the position/distance to other WTRUs, e.g., using positioning information or signals, e.g., using SL positioning signals. The WTRU 200 may receive the configuration information and may perform measurement of the timing offset to use to monitor signals from other WTRU.

The WTRU 200 may perform the corresponding measurements for one or more potential LP-Relay WTRUs. After performing the measurements based on the configuration received from the network, the WTRU 200 may report one or more of the measurements. The WTRU 200 may report, using RRC, MAC, UCI-based transmissions or reusing measurement reporting framework, e.g., CSI report resource and configuration. The WTRU 200 may report all the configured measurements for LP-relay selection to the network. The WTRU 200 may report part of the configured measurements for LP-relay selection to the network. For example, the WTRU 200 may filter the measurements and only report the ones above the configured measurement threshold. The WTRU 200 may also sort the measurements and report a (max) configured number of measurements reports. Further, the WTRU 200 may filter out WTRUs for which the time advance is not the same as the one for the WTRU 200, or for which the time difference is more than a threshold.

The WTRU 200 may include in the report: measurement result, that could be in one or more formats, the measurement report value, e.g., based on RSRP, RSSI, measurements that can be converted to smaller information indication, e.g., a binary flag indicating whether the measurement passed the threshold or not, a label, e.g., indicating the quality of the measurements (e.g., poor, medium, good, excellent), and using configured thresholds. The WTRU 200 may report the measured distance to the other WTRU, or the pathloss, e.g., based on positioning measurements. The WTRU 200 may report the time advance/offset it estimates for the transmission between the WTRUs.

The WTRU 200 may receive a second LP-WUS configuration (e.g., from the network, using SIB, RRC, MAC or DCI-based configuration), e.g., based on the reported measurements. The configuration content may be similar as previously described for a LP-relay-based monitoring. In one example, the WTRU 200 may receive the configuration in two steps, e.g., where the WTRU 200 receives a first part of the configuration that is generic to the LP-Relay itself, and a second part that is LP-Relay specific. This may help reduce the overhead and reconfiguration signaling when the WTRU 200 selects a LP-Relay or changes the LP-Relay.

The first and second parts may be sent separately, e.g., the second part being sent when the network configures a different LP-relay for the WTRU 200. The first part may include, e.g., LO/MO resources, LO/MO-PO mappings and LP-WUS ID/subgroup ID, LP signal format and configuration, entry/exit conditions etc. The second part may include the LP-Relay ID, and may further include reconfiguration of the first part configuration, e.g., replacing the first part configuration and indicate specific LO/MO resources, mapping, LP formats, etc. The WTRU 200 may start monitoring the LO/MO resource based on the second set of LP-WUS configuration, e.g., based on the determination of LP monitoring.

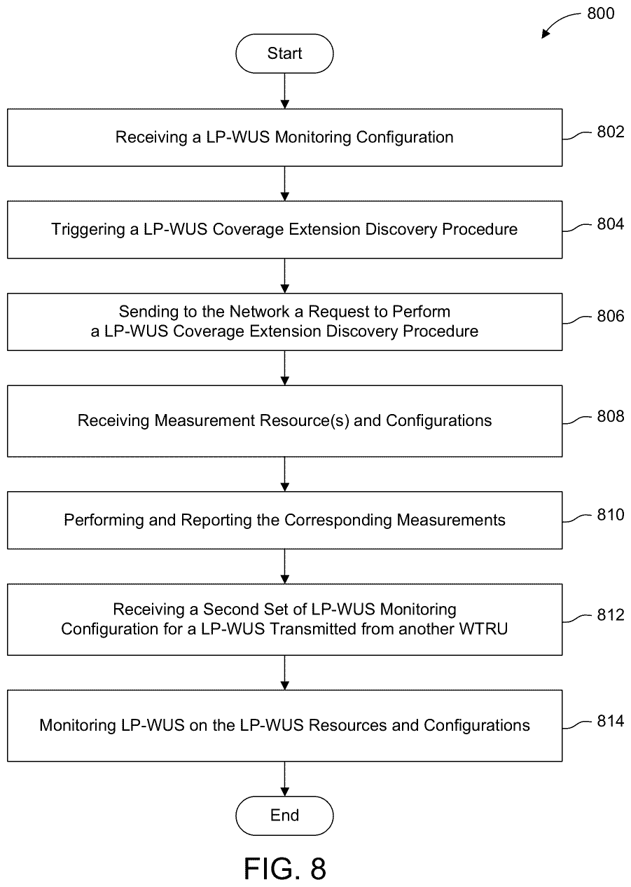

Referring now to FIG. 8, a flow diagram of a method 800 for performing LS-WUS relay discovering is illustrated, according to an exemplary embodiment. The method 800 may be implemented by a WTRU (e.g., WTRU 200). The WTRU may be configured with a first radio (e.g., a main radio or MR 202)) and a second radio (e.g., a low power radio or LR 204)). The method 500 may enable the WTRU 200 to discover and select or be configured with another WTRU as a relay. The WTRU may determine whether another WTRU is close enough to send/forward LP-WUS indications and to receive indication. The WTRU may send a discovery request to the network. The discovery request may be triggered by a MR/LR measurement (e.g. exit condition) to perform WTRU-based measurements for extending coverage of a LP-WUS. The WTRU may receive measurement configuration and may measure and report to the network.

At block 802, the method 800 may involve receiving a LP-WUS monitoring configuration for monitoring for at least one LP-WUS transmitted by at least one WTRU (e.g., a remote WTRU). For example, the WTRU may receive a LP-WUS monitoring configuration. The LP-WUS configuration may include LP-WUS resource occasions, LP-SS and associated configurations, LO-PO mapping, LP-WUS monitoring entry conditions (e.g., based on MR measurement>Threshold_mr and/or LR measurement>Threshold_lr), LP-WUS monitoring exit conditions (e.g., based on LR measurement<Threshold_lr),

At block 804, the method 800 may involve triggering a LP-WUS coverage extension discovery procedure based on: (i) the entry condition(s) for LP-WUS monitoring being satisfied (e.g. MR measurement<threshold _mr or MR measurement>threshold_mr+LR measurement<threshold_lr; and/or (ii) the condition that the WTRU stopped monitoring LP-WUS due to exit conditions (e.g. LR coverage<threshold_lr). At block 806, the method 800 may involve sending to the network a request to perform a LP-WUS coverage extension discovery procedure. The request may include MR or LR measurements, battery levels, etc. At block 808, the method 800 may involve receiving measurement resource(s) and configurations (e.g., measurement quantity, corresponding thresholds) corresponding to transmissions from other WTRU(s) (e.g. LP-WUS measurement on UL resources, SRS measurements (e.g., using SRS-RSRP), SL-based measurements, etc.).

At block 810, the method 800 may involve performing and reporting the corresponding measurements (e.g., limited to measurements above the thresholds and including timing alignment information, etc. At block 812, the method 800 may involve receiving a second set of LP-WUS monitoring configuration for a LP-WUS transmitted from another WTRU. At block 814, the method 800 may involve monitoring LP-WUS on the LP-WUS resources and configurations.

Referring again to FIG. 2, remote WTRUs may be connected to a relay WTRU via a SL/PC5 connection and may have direct communications between each other. For example, the remote WTRU 200 may receive configuration information to receive LP-WUS relaying to the remote, that may include using SL resources to receive LP-WUS or receive SL-based transmissions from the relay, e.g., for (de)activation. The WTRU 200 may transmit to the network the SL capabilities, LP-WUS-related SL capabilities (e.g., capability to receive/transmit indication to a LP-relay WTRU via SL), its active SL connections (e.g., list of ongoing SL connections and the corresponding WTRUs), etc. In SL, WTRUs may be identified using WTRU IDs or SL WTRU ID (e.g., L2 ID, Destination L2 ID, C-RNTI, Local ID, application ID).

The WTRU 200 may receive the LP-WUS relaying configuration information from one or more relay WTRUs with which it has a SL connection established. The LP-SS, LO/MO resources for reception are configured in resources designated as SL (e.g., in a SL carrier/BWP, SL time resource/resource pool) that the WTRU 200 is capable/configured to monitor. The WTRU 200 may be configured to receive the LP-WUS over SL resources configured with autonomous resource selection (e.g., NR SL Mode 2). The WTRU 200 may be configured to receive the LP-WUS over SL resources configured with grant-based resource selection (e.g., NR SL Mode 1). When the WTRU 200 is configured to monitor and synchronize over SL-SS, the WTRUs may be configured so that the LP-SS and SL-SS are the same signals if the Relay WTRU is transmitting SL-SS. The association/mapping between the set of LO/PO (e.g., over SL resources) and the PDCCH resources to monitor using the MR.

The WTRU 200 may receive this information from the network, e.g., using SIB, RRC, MAC or DCI indications. In some examples, the WTRU 200 may receive this information from the remote WTRU, e.g., using SL RRC, SL MAC or SCI indications. The WTRU 200 may transmit the LP-WUS relaying configuration information to the relay WTRU, instead of receiving it, e.g., using SL RRC configuration, SL MAC and/or SCI.

The (remote) WTRU 200 may be triggered to send a LP-Relay a relaying activation indication based on measurements, e.g., based on entry/exit conditions form the network. This may be similar to the previously described triggers for initiating the LP relaying from the remote WTRU. The WTRU 200 may be configured to evaluate WTRU related conditions before requesting the relay WTRU to activate/deactivate the LP-WUS relaying, e.g., in complement with previous conditions. The WTRU 200 may be configured with SL measurements, e.g., if WTRUs have established a SL/PC5 connection and the WTRU 200 may perform SL-RSRP/SL-RSSI measurements on SL transmissions made from the relay WTRU. If the measurement is beyond the threshold, the WTRU 200 may request the LP-WUS relaying. The WTRU 200 may be configured to perform SL positioning and evaluate the distance between the relay and remote WTRUs. If the distance is lower than a threshold, the WTRU 200 may perform the LP-WUS relaying.

The WTRU 200 may transmit an (de)activation of the LP-WUS relaying over SL, indicating to the Relay to start/stop the monitoring of a remote's WTRU. The WTRU 200 may transmit the SL indication directly to the relay WTRU, i.e., as an indicated source in the SCI of the transmission. For example, the WTRU 200 may transmit the indication within a dedicated new SCI or SCI indication, may transmit the indication as part of a SL MAC CE or SL RRC configuration, and/or may transmit the indication as a SL unicast transmission, a SL groupcast transmission or a SL broadcast transmission.

The WTRU 200 may be configured to receive a report from the relay WTRU to confirm or infirm that the relay is actually performing the LP Relaying, e.g., using SL resources, or HARQ feedback, PSCCH/PSSCH indication, etc. Upon reception of a LP relaying confirmation, the WTRU 200 may start monitoring the LO/MO resources associated with the relay WTRU, e.g., over SL resources. Upon reception of an indication that the LP Relay does not perform the relaying (or absence of confirmation), the WTRU 200 may select another relay to send the request from the list of LP relays, if any. If no other LP relay is available, the WTRU 200 may report to the network a request for LP-relay, e.g., trigger a LP relay selection procedure.

The WTRU 200 may determine a set of SL resources to monitor, based on the configuration between the WTRUs and/or the received configuration. The resources to monitor may include resources for LP-WUS receptions, e.g., LO/MO resources over SL resources, resources for “regular” SL receptions (PSCCH/PSSCH/PBSCH), e.g., resources corresponding to the SL DRX resources if configured, LP-SS over Sidelink resources, based on configuration, SL-SS over Sidelink resources, if the relay WTRU is configured to transmit SL-SS, etc. The LO/MO resources for LP-WUS reception may correspond to the SL-DRX resources for the remote WTRU, or a subset of it. In some examples, the LO/MO resources for LP-WUS reception may be different than the SL-DRX resources for the remote WTRU, and the remote WTRU may use different radio to monitor the different signals. The LOs are mapped to LP-SS and/or SL-SS, e.g., for synchronization and beam purposes.

The WTRU 200 may receive a LP-WUS and may detect its ID/subgroup in a monitored LO/PO resource. The WTRU 200 may then determine the PDCCH resources to monitor, based on the received LP-WUS (e.g., based on the SL resource/time of the resource) and the corresponding LO/MO to PO mapping. The WTRU 200 may further wake-up its MR 202 to monitor for the PDCCH or may perform corresponding LP-WUS related actions. For instance, receiving paging or network configurations, transmitting RACH etc.

The WTRU 200 may receive a SL transmission including a LP-WUS indication and may detect its ID/subgroup in a monitored SL resource. The WTRU 200 may then determine the PDCCH resources to monitor, based on the received LP-WUS indication (e.g., based on the SL resource/time of the resource) and the corresponding SL resource to PO mapping. The WTRU 200 may further wake-up its MR 202 (if needed) to monitor for the PDCCH or perform corresponding LP-WUS related actions. For instance, receiving paging or network configurations, transmitting RACH etc. In the case of SL-based transmission, the transmission may include the mapping or an indication for PDCCH monitoring and the WTRU 200 may use this to determine the resources.

The WTRUs may autonomously manage and configure the LP-WUS relaying with limited to no indication from the network. The WTRUs, e.g., a set of WTRU from a same group of devices (XR, IoT, industrial devices/sensors etc.) or belonging to a same user, may have (pre)configuration to perform LP-WUS relaying to each other. The following aspect may be considered as complement or replacement of network-controlled versions described previously, in all or parts.

The WTRU 200 may send its SL capabilities, LP-WUS monitoring, and LP-WUS relaying capabilities to another WTRU, e.g., via SL RRC, SL MAC CE or SCI indications, or obtained through pre-configurations. The (remote) WTRU 200 may receive the LP-WUS relaying configuration from another WTRU, e.g., including the LP-WUS monitoring configurations (LO/MO resources, timings, IDs/subgroup, etc.) that the WTRU 200 monitors, e.g., over SL resources, from the relay WTRU, e.g., via SL RRC, SL MAC CE or SCI indications. The WTRU 200 may receive from the relay WTRU a configuration for receiving the LP-WUS indication, e.g., using LP-WUS and/or SL based indication, and including the resources on which to receive. For example, using SL resources.

The WTRU 200 may transmit to the relay WTRU a configuration for transmitting the LP-WUS indication, e.g., using LP-WUS and/or SL based indication, and including the resources on which to transmit. For instance, using SL resources. The WTRU 200 may also transmit an indication from the relay WTRU to monitor its LP-WUS, e.g., via SL RRC, SL MAC CE or SCI indications and may start to monitor the relayed LO/MO resources to detect the corresponding ID/subgroup indication. The remote WTRU (e.g., WTRU 200) may monitor the relayed LO/MO and may detect a LP-WUS or LP-WUS indication targeting the remote WTRU. The WTRU may then determine the PDCCH monitoring resources and may monitor the PDCCH accordingly.

In SL HARQ configuration for LP-WUS relaying, a network may configure a SL feedback configuration for LP-WUS relaying to a relay WTRU (e.g., LP-WUS relay WTRU) and/or a remote WTRU (e.g., LP-WUS remote WTRU). For example, the relay WTRU and/or the remote WTRU (e.g., WTRU 200) may receive an RRC message (e.g., cell-specific and/or dedicated WTRU) and be configured the SL feedback configuration for LP-WUS relaying. For example, the SL feedback configuration may comprise one or more SL resource pools (e.g., SL transmission/reception) and/or associated SL logical channels. For example, the SL feedback configuration may comprise at least one SL resource pool configured with PSFCH (Physical Sidelink Feedback Channel) and/or associated at least one SL logical channel with SL feedback being enabled.

The relay WTRU may transmit a SL feedback configuration to a remote WTRU (e.g., WTRU 200) via PC5 interface (e.g., PC5-RRC message) after a PC5-RRC connection is established between the relay WTRU and remote WTRU (e.g., WTRU 200). For example, a relay WTRU may configure additional/dedicated configuration of LP-WUS monitoring for the remote WTRU (e.g., WTRU 200). For example, the configuration may comprise a specific (or a portion of) SL resource pool(s) and/or time window and/or time duration and/or PSCCH/PSSCH and/or a specific SL BWP for LP-WUS monitoring. For example, a relay WTRU may configure additional/dedicated configuration of SL feedback of LP-WUS reception for the remote WTRU (e.g., WTRU 200). For example, the configuration may comprise a specific (or a portion of) SL resource pool(s) and/or time window and/or time duration and/or PSCCH/PSFCH and/or a specific SL BWP for feedback of LP-WUS reception.

A relay WTRU (e.g., LP-WUS relay WTRU) may transmit an LP-WUS to a remote WTRU (e.g., (e.g., the WTRU 200 or a LP-WUS remote WTRU) upon receiving an LP-WUS from a network. For example, the relay WTRU may transmit the received LP-WUS via an SL transmission with an SL resource transmission pool configured with PSFCH resource. For example, the relay WTRU may perform multiplex into the same (or different) SL MAC PDU configured with one or more SL logical channels (e.g., SL feedback is enabled). For example, one LP-WUS relaying transmission is associated with at least one SL HARQ feedback and/or at least one SL HARQ process ID. For example, LP-WUS may be transmitted within an SL TB and/or piggybacking/multiplexed with SL data within an SL TB.

Upon transmitting an SL transmission including LP-WUS, a relay WTRU may receive one or more SL feedback (e.g., ACK/NACK) via PSFCH resource from remote WTRU(s) as a response of the SL transmission of the LP-WUS. Upon receiving the SL feedback of LP-WUS from a remote WTRU (e.g., the WTRU 200), the relay WTRU may report the received ACK/NACK via PUCCH to the network. For example, network may determine whether the LP-WUS relaying for a remote WTRU is successful or not based on the feedback from the relay WTRU. For example, the network may perform retransmission of LP-WUS upon receiving the NACK from the relay WTRU. For example, the relay WTRU may perform retransmission of LP-WUS for the remote WTRU upon receiving LP-WUS from network.

Upon receiving an indication of activation of LP-WUS relaying from a network, the relay WTRU may transmit an LP-WUS to a remote WTRU (e.g., WTRU 200). For example, the network may transmit an indication (or a message) via DCI/MAC CE/SIB/RRC message. The indication may include one or more remote WTRU ID (e.g., L2 ID, Destination L2 ID, C-RNTI, Local ID, application ID). For example, the indication may include information for initial transmission and/or retransmission of LP-WUS.

Upon receiving an LP-WUS with at least one remote WTRU ID and/or LP-WUS subgroup ID, a relay WTRU may determine to transmit the received LP-WUS to the specific remote WTRU (e.g., WTRU 200). and/or group of remote WTRUs. For example, a relay may perform unicast LP-WUS relaying for a remote WTRU and/or may perform groupcast for LP-WUS relaying for a subgroup based on the reception ID(s). The relay WTRU may determine to activate/perform LP-WUS relaying for a remote WTRU (e.g., WTRU 200). For example, the relay WTRU may determine to activate LP-WUS relaying for a remote WTRU when the measured SL-RSRP/SL-RSRQ/SL-RSSI is above than the configured threshold (e.g., SL entry condition is satisfied). The relay WTRU may also determine to activate/perform LP-WUS relaying for the remote WTRU (e.g., WTRU 200) once the relay WTRU is satisfied with a configured LP-WUS entry condition (e.g., measured MR measurement results and/or LR measurement results is above than the thresholds (e.g., entry condition is satisfied)). The relay WTRU may receive an explicit request of LP-WUS relaying from a remote WTRU (e.g., WTRU 200). For example, the relay WTRU may receive a PC5-RRC message including LP-WUS relaying request.

Upon receiving an indication of deactivation of LP-WUS relaying from network, a relay WTRU may stop transmitting/relaying an LP-WUS to a remote WTRU(e.g., WTRU 200). For example, the relay WTRU may determine to deactivate LP-WUS relaying for a remote WTRU (e.g., WTRU 200) if measured SL-RSRP/SL-RSRQ/SL-RSSI is below the configured threshold (e.g., SL exit condition is satisfied). The relay WTRU may also determine to deactivate LP-WUS relaying for a remote WTRU (e.g., WTRU 200) once the relay WTRU is satisfied with the LP-WUS exit condition. For example, measured MR measurement results and/or LR measurement results is below than the thresholds (e.g., exit condition is satisfied). Further, the relay WTRU may determine to deactivate LP-WUS relaying for a remote WTRU (e.g., WTRU 200) once the relay WTRU determined to move to another cell (e.g., handover, cell (re-)selection). For example, the relay WTRU may send an explicit request of deactivation to the remote due to relay WTRU's mobility. In addition, the relay WTRU may determine to deactivate LP-WUS relaying for a remote WTRU (e.g., WTRU 200) once the number of DTX is reached for a configured threshold. For example, a relay WTRU may increase the number of DTX if the relay WTRU fails to receive feedback related SL transmission with LP-WUS relaying. The relay WTRU may also determine to deactivate LP-WUS relaying with a remote WTRU (e.g., WTRU 200) once the PC5-RRC connection is released and/or upon detection of SL-RLF for the PC5-RRC connection. Further, the relay WTRU may receive an explicit request of deactivation for LP-WUS relaying from a remote WTRU(e.g., WTRU 200). For example, the relay WTRU may receive a PC5-RRC message including LP-WUS relaying request.

The WTRU may determine to activate/perform LP-WUS relaying for a remote WTRU (e.g., WTRU 200) when the measured SL-RSRP/SL-RSRQ/SL-RSSI from a remote WTRU (e.g., WTRU 200) is above than a threshold (e.g., successful for SL data transmission is satisfied). The relay WTRU may also determine to activate/perform LP-WUS relaying for a remote WTRU (e.g., WTRU 200 when a relay WTRU condition (e.g., L2 relay and/or L3 relay WTRU) is satisfied. For example, a relay WTRU may determine to activate upon receiving PC5-capability information (e.g., supporting OOK based LP-WUR and/or OFDM based LP-WUR) from remote WTRU (e.g., WTRU 200).

The relay WTRU may determine to deactivate LP-WUS relaying for a remote WTRU (e.g., WTRU 200) once the measured SL-RSRP/SL-RSRQ/SL-RSSI from remote WTRU is below than a threshold. (e.g., successful SL data transmission is not satisfied). The relay WTRU may also determine to deactivate LP-WUS relaying for a remote WTRU when relay WTRU condition (e.g., L2 relay and/or L3 relay WTRU) is not satisfied. Combinations of the above factors are also possible: one or another condition (e.g., explicit/implicit) being satisfied, multiple conditions being satisfied, a threshold for one condition being computed by another factor, etc.

The remote WTRU (e.g., the WTRU 200 or a LP-WUS remote WTRU) may receive an LP-WUS from a relay WTRU (e.g., LP-WUS relay WTRU). Upon receiving the LP-WUS from the relay WTRU, the remote WTRU (e.g., WTRU 200) may transmit/respond SL feedback (ACK/NACK) via PSFCH resource for the reception of LP-WUS from relay WTRU. Upon receiving an LP-WUS from a relay WTRU, the remote WTRU may monitor and respond for the reception of LP-WUS.

The remote WTRU (e.g., WTRU 200) may determine to activate/perform LP-WUS relaying from a relay WTRU. For example, the remote WTRU (e.g., WTRU 200) may determine to activate/perform LP-WUS relaying from a relay WTRU if the measured SL-RSRP/SL-RSRQ/SL-RSSI is above than a configured threshold (e.g., SL entry condition is satisfied). The remote WTRU (e.g., WTRU 200) may transmit an explicit request of LP-WUS relaying to the relay WTRU once detecting the LP-WUS exit condition being satisfied (e.g., measured MR measurement results and/or LR measurement results is below than the thresholds (e.g., exit condition is satisfied)). For example, the remote WTRU (e.g., WTRU 200) may transmit a PC5-RRC message including LP-WUS relaying request of activation. The remote WTRU (e.g., WTRU 200) may also transmit a PC5-RRC message including LP-WUS relaying request of activation. For example, the requested activation may comprise PC5-capability information (e.g., supporting OOK based LP-WUR and/or OFDM based LP-WUR).

Upon receiving an indication of deactivation of LP-WUS relaying from a relay WTRU, the remote WTRU (e.g., WTRU 200) may stop monitor and receive LP-WUS from a relay WTRU. For example, the remote WTRU (e.g., WTRU 200) may deactivate to monitor LP-WUS relaying signal from a relay WTRU if measured SL-RSRP/SL-RSRQ/SL-RSSI is below than a configured threshold. (e.g., SL exit condition is satisfied). The remote WTRU (e.g., WTRU 200) may deactivate to monitor LP-WUS relaying signal from a relay WTRU once the remote WTRU (e.g., WTRU 200) is satisfied with LP-WUS entry condition (e.g., the measured MR measurement results and/or LR measurement results is above than the thresholds (e.g., entry condition is satisfied)). For example, the remote WTRU (e.g., WTRU 200) may transmit a PC5-RRC message including LP-WUS relaying request of deactivation. Combinations of the above factors are also possible: one or another condition (e.g., explicit/implicit) being satisfied, multiple conditions being satisfied, a threshold for one condition being computed by another factor, etc.

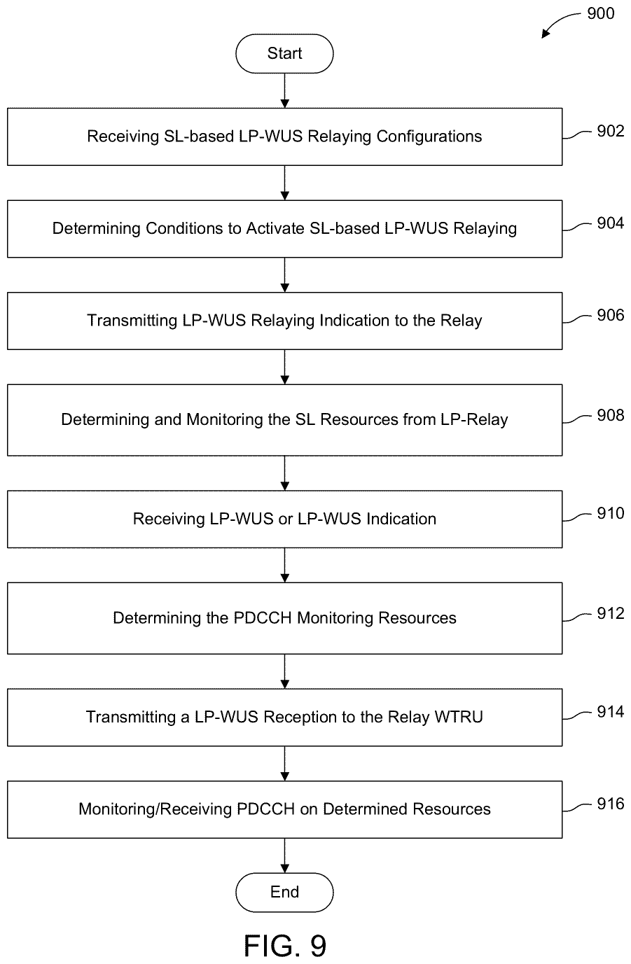

Referring now to FIG. 9, a flow diagram of a method 900, according to an exemplary embodiment, is illustrated for LP-WUS relaying and reporting LP-WUS reception. The method 900 may be implemented by a WTRU (e.g., WTRU 200). The WTRU may be configured with a first radio (e.g., a main radio or MR 202)) and a second radio (e.g., a low power radio or LR 204)). The WTRU may monitor for LP-WUSs transmitted by a network and LP-WUSs transmitted by another WTRU, such as a relay WTRU. The WTRU may be configured with two sets of LP-WUS monitoring configurations (e.g., entry/exit conditions, LO-PO mapping). The WTRU may select/apply the configuration based on whether the WTRU receives or monitors for a LP-WUS from another WTRU or network.

At block 902, the method 900 involves receiving a SL-based LP-WUS relaying configuration. For example, the WTRU may receive the configuration for LP-WUS relaying over SL. The SL-based LP-WUS monitoring configuration may include LP-WUS monitoring resources over SL (e.g., resource pool using Mode 2) from the relay WTRU, LP-WUS to paging occasion mapping based on SL resources to PDCCH mapping, a LP-WUS relaying configuration, associated SL HARQ resources, triggers for LP-WUS relaying activation based on measurements below a threshold (e.g., network-based exit conditions passed), etc. At block 904, the method 900 involves determining conditions to activate SL-based LP-WUS relaying (e.g., exit-conditions).

At block 906, the method 900 involves transmitting a LP-WUS relaying indication to the relay, such as over the SL. At block 908, the method may involve determining and monitoring the SL resources from the LP-Relay (e.g., LP-SS, LO/MO and/or SL-based indications). For example, the WTRU may monitor and synchronize on LP-SS or SL-SS over the SL resources. The WTRU may also monitor LO/MO with LR on SL resources and may monitor SL-based LP-WUS indication on SL resources based on SL DRX.

At block 910, the method 900 may involve receiving the LP-WUS/P-WUS indication, such as over the SL resource. The method may also include detecting/identifying the WTRU ID/subgroup. At block 912, the method 900 may involve determining and monitoring the PDCCH monitoring resources based on the received indication, its resource/format, and the configured mapping. At block 914, the method 900 may involve transmitting a LP-WUS reception of the relay WTRU, such as using PSFCH. At block 916, the method 900 may involve monitoring and receiving PDCCH on the determine resources. The method may also involve applying the corresponding behavior (e.g. initiate RACH, apply received configuration etc.).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

### ABBREVIATIONS AND ACRONYMS

ACK Acknowledgement
BLER Block Error Rate
BWP Bandwidth Part
C-DRX Connected mode DRX
CE Control Element
CG Configured grant or cell group
CP Cyclic Prefix
CP-OFDM Conventional OFDM (relying on cyclic prefix)
CQI Channel Quality Indicator
CQI Channel Quality Information
CRC Cyclic Redundancy Check
CRI CSI-RS Resource Indicator
CSI Channel State Information
CSI Channel State Information
DCI Downlink Control Information
DCI Downlink Control Information
DFI Downlink feedback information
DG Dynamic grant
DL Downlink
DM-RS Demodulation Reference Signal
DRB Data Radio Bearer
DRX Discontinuous Reception
HARQ Hybrid Automatic Repeat Request
LI Layer Indicator
LP Low Power
LO LP-WUS occasions
LR Low power Radio
LTE Long Term Evolution e.g. from 3GPP LTE R8 and up
MAC Medium Access Control
MCS Modulation and Coding Scheme
MIMO Multiple Input Multiple Output
MO LP-WUS Monitoring Occasion
MR Main Radio
NACK Negative ACK
NR New Radio
NW Network
OFDM Orthogonal Frequency-Division Multiplexing
P(U/D)CCH Physical Uplink/Downlink Control Channel
P(U/D)SCH Physical Uplink/Downlink Shared Channel
PBCH Physical Broadcast Channel
PHY Physical Layer
PMI Precoding Matrix Indicator
PO Paging Occasion
PRACH Physical Random Access Channel
PSS Primary Synchronization Signal
RA Random Access (or procedure)
RACH Random Access Channel
RAR Random Access Response
RCU Radio access network Central Unit
RF Radio Front end
RI Rank Indicator
RLF Radio Link Failure
RLM Radio Link Monitoring
RNTI Radio Network Identifier
RO RACH occasion
RRC Radio Resource Control
RRM Radio Resource Management
RRM Radio Resource Management
RS Reference Signal
RS Reference Signal
RSRP Reference Signal Received Power
RSRP Reference Signal Received Power
RSSI Received Signal Strength Indicator
SDU Service Data Unit
SPS Semi-persistent scheduling
SRS Sounding Reference Signal
SRS Sounding Reference Signal
SS Synchronization Signal
SS Synchronization Signal
SSBRI SS/PBCH Resource Block Indicator
SSS Secondary Synchronization Signal
SUL Supplemental Uplink
SWG Switching Gap (in a self-contained subframe)
TB Transport Block
TBS Transport Block Size
TRP Transmission/Reception Point
TSC Time-sensitive communications
TSN Time-sensitive networking
UL Uplink
URLLC Ultra-Reliable and Low Latency Communications
WBWP Wide Bandwidth Part
WLAN Wireless Local Area Networks and related technologies (IEEE 802.xx domain)
WUR Wake up Radio
WUS Wake up Signal

What is claimed:

1. A first wireless transmit/receive unit (WTRU) comprising:
a first radio;
a second radio; and
a processor configured to:
receive first configuration information for monitoring for at least one low power wake-up signal (LP-WUS) transmitted by a network;
receive second configuration information for monitoring for at least one LP-WUS transmitted by a second WTRU; and
activate the second radio to monitor for a first LP-WUS transmitted by the network based on the first configuration information and to monitor for a second LP-WUS transmitted by the second WTRU based on the second configuration information.

2. The WTRU of claim 1, wherein the first radio comprises a main radio (MR), wherein the second radio comprises a low power wake-up radio (LP-WUR), and wherein the second WTRU comprises one or more relay WTRUs.

3. The WTRU of claim 1, wherein the processor is further configured to cause the first radio to start monitoring for a paging occasion in response to the first LP-WUS received from the network or the second LP-WUS received from the second WTRU.

4. The WTRU of claim 1, wherein the first configuration information includes at least one threshold, wherein the processor is further configured to:
perform at least one measurement of one or more reference signals received by the first radio or the second radio from the network; and
compare the at least one measurement to the at least one threshold, wherein the activation of the second radio is based on the comparison.

5. The WTRU of claim 4, wherein the processor is further configured to:
receive, via the second radio, the first LP-WUS from the network according to the first configuration information; and
activate the first radio to monitor, using the first configuration information, for at least one paging occasion upon receiving the first LP-WUS.

6. The WTRU of claim 1, wherein the first configuration information further includes at least one threshold, wherein the processor is further configured to:
perform at least one measurement of one or more reference signals received by the first radio or the second radio from the network;
compare the at least one measurement to the at least one threshold; and
cause the second radio to discontinue or stop monitoring for the LP-WUS based on the comparison.

7. The WTRU of claim 6, wherein the processor is further configured to activate the first radio to monitor, using the first configuration information, for at least one paging occasion based on the comparison.

8. The WTRU of claim 1, wherein the second configuration information includes at least one threshold, wherein the processor is further configured to:
perform at least one measurement of one or more reference signals received by the first radio or the second radio from the second WTRU; and
compare the at least one measurement to the at least one threshold, wherein activating the second radio is based on the comparison.

9. The WTRU of claim 8, wherein the processor is further configured to:
receive, via the second radio, the second LP-WUS from the second WTRU according to the second configuration information; and
activate the first radio to monitor, using the second configuration information, for at least one a paging occasion upon receiving the LP-WUS.

10. The WTRU of claim 1, wherein the second configuration information further includes at least one threshold, wherein the processor is further configured to:
perform at least one measurement of one or more reference signals received by the first radio or the second radio from the second WTRU;
compare the at least one measurement to the at least one threshold; and
cause the second radio to discontinue or stop monitoring for the LP-WUS based on the comparison.

11. The WTRU of claim 10, wherein the processor is further configured to activate the first radio to monitor, using the second configuration information, for at least one paging occasion based on the comparison.

12. The WTRU of claim 1, wherein the processor is further configured to cause an indication to be transmitted to the network upon activating or deactivating monitoring for LP-WUSs from the second WTRU.

13. The WTRU of claim 1, wherein the first configuration information includes a first LP-WUS reception to paging occasion mapping, wherein the second configuration information includes a second LP-WUS reception to paging occasion mapping, and wherein the first and second LP-WUS reception to paging occasion mapping maps to a same paging occasion.

14. The WTRU of claim 1, wherein the WTRU is configured to monitor for LP-WUSs in a radio resource control (RRC) inactive mode or state or a RRC idle mode or state.

15. The WTRU of claim 1, wherein the first configuration information is received from the network, and wherein the second configuration information is received from the network or the second WTRU.

16. A method implemented by a first wireless transmit/receive unit (WTRU) having a first radio and a second radio, the method comprising:
receiving first configuration information for monitoring for at least one low-power wake-up signal (LP-WUS) transmitted by a network;
receiving second configuration information for monitoring for at least one LP-WUS transmitted by a second WTRU; and
activating the second radio to monitor for a first LP-WUS transmitted by the network based on the first configuration information and to monitor for a second LP-WUS transmitted by the second WTRU based on the second configuration information.

17. The method of claim 16, wherein the first radio comprises a main radio (MR), wherein the second radio comprises a low power wake-up radio (LP-WUR), and wherein the second WTRU comprises one or more relay WTRUs.

18. The method of claim 16, further comprising causing the first radio to start monitoring for a paging occasion in response to the LP-WUS received from the network or the second LP-WUS received from the second WTRU.

19. The method of claim 16, wherein the second configuration information includes at least one threshold, and further comprising:
performing at least one measurement of one or more first reference signals received by the first radio or the second radio from the second WTRU; and
comparing the at least one measurement to the at least one threshold, wherein activating the second radio is based on the comparison.

20. The method of claim 16, wherein the second configuration information further includes at least one threshold, and further comprising:
performing at least one measurement of one or more reference signals received by the first radio or the second radio from the second WTRU;
comparing the at least one measurement to the at least one threshold; and
causing the second radio to discontinue or stop monitoring for the second LP-WUS based on the comparison.
